(19) United States
(12) Patent Application Publication
(10) Pub. No.: US 2021/0319413 A1
(43) Pub. Date: Oct. 14, 2021

(54) TICKETING SYSTEM, TICKET MANAGEMENT DEVICE, AND PAYMENT METHOD

(71) Applicant: MITSUI & CO., LTD., Tokyo (JP)

(72) Inventors: Takuya SAEKI, Tokyo (JP); Daichi FUKUSHIMA, Tokyo (JP); Kotaro MANABE, Tokyo (JP)

(21) Appl. No.: 17/271,840

(22) PCT Filed: Mar. 18, 2019
(86) PCT No.: PCT/JP2019/011225

§ 371 Date: Feb. 26, 2021

(30) Foreign Application Priority Data
Aug. 31, 2018 (JP) 2018-162954

(51) Int. Cl. G06Q 20/04; G06Q 30/02; G06Q 20/32; G06Q 20/38; G06Q 20/36

(52) U.S. Cl. CPC G06Q 20/045; G06Q 30/0226; G06Q 20/3674; G06Q 20/3825; G06Q 20/3276

(57) ABSTRACT

Tickets to which a number of points associated to points of a first user are allotted are issued, identification information is output based on the tickets, the identification information is received, the ticket corresponding to the identification information is identified, the number of points allotted to the ticket is added to points of the second user, and the ticket for which points have been allotted to the user is deleted from among the issued tickets. Because of this, a ticketing system, or the like, such that a transfer of points can be carried out easily and flexibly between users utilizing a system, such as a producer and a customer, by utilizing a ticket can be provided.

### TECHNICAL FIELD

The present disclosure relates to a ticketing system and the like. The present application claims the benefit of priority of Patent Application No. 2018-162954, filed in Japan on Aug. 31, 2018, the whole of which is incorporated herein by reference.

### BACKGROUND ART

Systems that utilize points, electronic money, or a virtual currency are already known. By utilizing these systems, for example, a customer purchases a product, or a shop grants a customer with a privilege.

For example, Patent Literature 1 is such that when declaring an intent to pay for a transaction using an electronic money card, an electronic money balance and a money ranking are acquired via a read/write portion, and the electronic money balance and the money ranking are indicated on a display. Further, an invention disclosed is such that a transaction payment process is carried out by a total sales amount being deducted from an electronic money balance and the reduced electronic money balance being rewritten, current points are calculated by a money ranking and points being multiplied, and the current points are written into an electronic money card.

### CITATION LIST

### Patent Literature

Patent Literature 1: JP-A-2010-97559

### SUMMARY OF INVENTION

### Technical Problem

With an existing system, There is no idea of transferring points between users of the system (a producer and a customer), because of which a flexible system has not been realized.

For example, when a system gives points to a customer, the points are given in accordance with a purchase amount. Also, even when a number of points is changed for each product by utilizing a system, the points are given at a time of purchase, because of which a producer cannot give points (transfer producer points to a customer) for each product independent of purchase.

With consideration to the heretofore described problem, the present disclosure has an object of providing a ticketing system, or the like, such that a transfer of points can be carried out easily and flexibly between users utilizing a system, such as a producer and a customer, by utilizing a ticket.

### Solution to Problem

A ticketing system of the present disclosure is a ticketing system including a terminal device, a point management device that manages user points, and a ticket management device, and is characterized in that the ticket management device includes an issuing unit that issues tickets to which a number of points associated to points of a first user are allotted, an output unit that outputs an identification code based on the tickets, a receiving unit that receives user information and the identification code from the terminal device, an identification unit that identifies a ticket corresponding to the identification code, and a ticket processing unit that adds the number of points allotted to the identified ticket to points of a second user identified from the user information, and deletes the ticket for which the points have been added from the issued tickets.

A ticketing system of the present disclosure is a payment system including a terminal device, a point management system that manages user points, and a ticket management server, and is characterized in that the ticket management device generates a token including information relating to a number of points associated to points of a first user and a condition of use, and issues a ticket on which identification information in which the token is included is described, the terminal device acquires the token from the identification information of the ticket, and transmits the token and information relating to a second user corresponding to the terminal device to the ticket management device, and the ticket management device identifies a ticket from the received token, subtracts the number of points allotted to the identified ticket from the points of the first user, adds the number of points allotted to the identified ticket to points of the second user, and deletes the identified ticket from issued tickets.

A ticket management device of the present disclosure is a ticket management device including a control unit and a communication unit that carries out communication with a point management device that manages a terminal device and user points, and is characterized in that the control unit issues tickets to which a number of points associated to points of a first user are allotted, outputs identification information based on the tickets, receives user information and the identification information via the communication unit from the terminal device, identifies a ticket corresponding to the identification information, adds the number of points allotted to the identified ticket to points of a second user identified from the user information, and deletes the ticket for which the points have been added from the issued tickets.

A payment method of the present disclosure is a payment method in a ticketing system including a point management device that manages user points and a ticket management device, and is characterized in that the ticket management device includes a step of issuing tickets to which a number of points associated to points of a first user are allotted, a step of outputting identification information based on the tickets, a step of receiving user information and the identification information, a step of identifying a ticket corresponding to the received identification information, and a step of adding the number of points allotted to the identified ticket to points of a second user identified from the user information, and deleting the ticket for which the points have been added from the issued tickets.

### Advantageous Effects of Invention

According to the present disclosure, a system or the like such that a transfer of points can be carried out easily and flexibly between users by utilizing a ticket can be provided.

### BRIEF DESCRIPTION OF DRAWINGS

FIG. 1 is a drawing for describing an outline in a first embodiment.

FIG. 2 is a drawing for describing an overall configuration in the first embodiment.

FIG. 3(a) is a drawing for describing a configuration of a ticket management server, and FIG. 3(b) is a drawing for describing an example of a configuration of ticket data, in the first embodiment.

FIG. 4 is a drawing for describing an example of a configuration of ticket data in the first embodiment.

FIG. 5 is a drawing for describing an example of a configuration of ticket data in the first embodiment.

FIG. 6(a) is a drawing for describing a configuration of a point management server, and FIG. 6(b) is a drawing for describing an example of a configuration of point data, in the first embodiment.

FIG. 7 is a drawing for describing a configuration of a management device in the first embodiment.

FIG. 8 is a drawing for describing a configuration of a terminal device in the first embodiment.

FIG. 9 is a drawing for describing a system outline relating to a point transfer in the first embodiment.

FIG. 10 is a drawing showing an operation of a ticket issuing process in the first embodiment.

FIG. 11 is a drawing showing an operation of a ticket managing process in the first embodiment.

FIG. 12 is a drawing showing an operation of a payment process in the first embodiment.

FIG. 13 is a drawing showing an operation example (a process screen when issuing a ticket) in the first embodiment.

FIG. 14 is a drawing showing an operation example (a display screen of the terminal device when receiving a ticket) in the first embodiment.

FIG. 15 is a drawing showing an operation example (a display screen of the terminal device when receiving a ticket) in the first embodiment.

FIG. 16 is a drawing illustrating an increase and a decrease of points in the first embodiment.

FIG. 17 is a drawing showing an operation example (a process screen when issuing a ticket) in the first embodiment.

FIG. 18 is a drawing showing an operation example (a display screen of the terminal device when receiving a ticket) in the first embodiment.

FIG. 19 is a drawing showing an operation of a ticket issuing process in a second embodiment.

FIG. 20 is a drawing illustrating an increase and a decrease of points in the second embodiment.

FIG. 21 is a drawing illustrating an increase and a decrease of points in a third embodiment.

FIG. 22 is a drawing for describing a system outline relating to a point transfer in a fifth embodiment.

FIG. 23 is a drawing showing an operation of a ticket issuing process in tie fifth embodiment.

FIG. 24 is a drawing showing an operation of a payment process in the fifth embodiment.

FIG. 25 is a drawing for describing an example of a configuration of ticket data in a sixth embodiment.

FIG. 26 is a drawing illustrating an application example of the system.

### DESCRIPTION OF EMBODIMENTS

Hereafter, one embodiment for implementing the invention will be described, with reference to the drawings. For the sake of the description, a system wherein an electronic ticket is utilized for transferring points will be described as the embodiment, but as a concept is that a virtual currency or electronic money are included in the points, the same kind of process can be realized. Also, as an electronic ticket is also called a virtual ticket or the like, an electronic ticket will hereafter be referred to simply as a “ticket”.

### 1. First Embodiment

1.1 System Outline

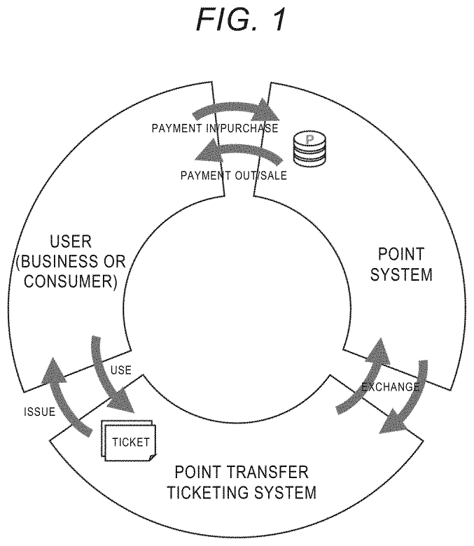

A concept of the system in this embodiment will be described, referring firstly to FIG. 1. A point system that manages points, a ticketing system that manages a ticket for carrying out a transfer of points, and users of the system, such as a business or a consumer, are included in the embodiment.

A point system is such that points of each user are managed by, for example, a point management server using a wallet. In the embodiment, points are described as points that a user can buy, but the concept includes a virtual currency and electronic money. For example, in the case of a virtual currency or electronic money, a wallet balance (a virtual currency or electronic money) increases by a user paying into the wallet.

Also, a wallet is a virtual area in which points are managed and stored. A wallet maybe realized by an application, or may be provided by an online service. Herein, a wallet generally indicates a billfold, but the concept includes, for example, an account that manages points. Herein, a wallet may be a user wallet in which all points that a user can utilize are managed and stored, or a ticket wallet in which points utilized in issuing, using, or the like a ticket of the embodiment are managed and stored. Referring simply to a wallet in the embodiment indicates a user wallet and/or a ticket wallet.

A point system may be realized by utilizing a blockchain. A blockchain is a distributed ledger system utilized in, for example, a virtual currency payment system.

Transferring points between users (between wallets) can be carried out in the embodiment by utilizing a virtual electronic ticket (a ticket) of the system. For example, a first user exchanges points and a ticket, and issues a ticket. By a second user using the ticket, a wallet point balance of the second user increases by an amount of points equivalent to the ticket.

That is, what it is expected to realize using the system is that points managed and stored by a first user and points managed and stored by a second user can be carried out easily by utilizing a ticket.

1.2 Overall System Configuration

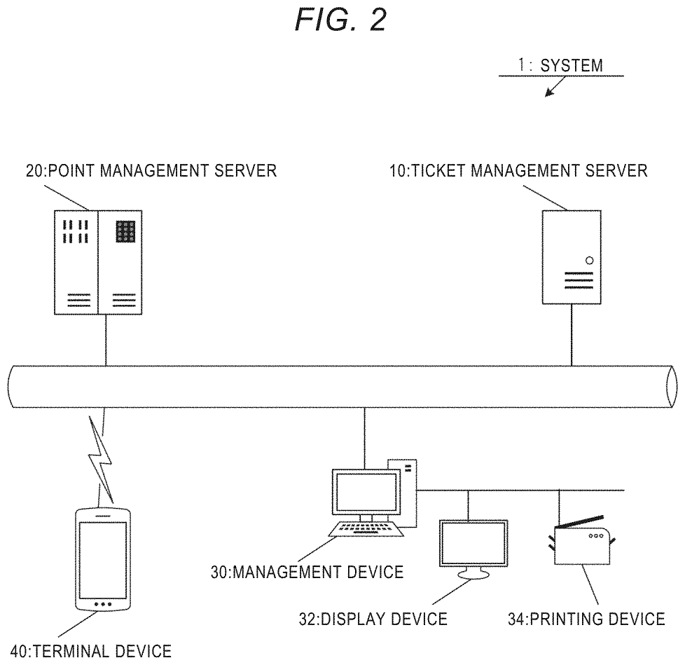

An overall system configuration will be described, with reference to FIG. 2. As shown in FIG. 2, a system 1 is such that a ticket management server 10, which is a ticket management device, a point management server 20, which is a point management device, a management device 30, and a terminal device 40 are connected via a network NW. In FIG. 2, the system configuration is illustrated in a simplified form, but a multiple of each device may be included.

For example, the management device 30 and the terminal device 4 0 are connected for each user. Also, the point management server 20 may be provided for each point service enterprise, rather than being a single server device. For example, an existing point service, such as T-POINT (registered trademark), dPOINT (registered trademark), or Ponta (registered trademark), can be utilized. Furthermore, the point management server 20 may be realized using a blockchain. That is, it is sufficient that points of a user are managed in a point management system.

A display device 32, which displays an identification code (identification information) in which a token identifying a ticket is included, and a printing device 34 on which the identification code is printed may be connected to the management device 30. For example, the display device 32 is a cash register device or a digital signage device, and displays a two-dimensional code as an identification code. Also, the printing device 34 prints a label on which a two-dimensional code is printed as an identification code. A user (for example, a producer) can attach a label on which a two-dimensional code is printed to a product, or print a product label including a two-dimensional code.

Identification information is information for identifying a ticket. The concept of identification information includes information itself, such as a token or identification ID, or identification information printed or displayed in accordance with an identification code, such as a one-dimensional code that indicates the information or a two-dimensional code that indicates the information. That is, there is a case wherein a token that specifies (identifies) a ticket is called identification information, and there is a case wherein a two-dimensional code (identification code) itself, including information indicating a token, is called identification information.

1.3 Device Configuration

Continuing, a configuration of each device included in the system 1 will be described. Firstly, configurations common to each server and each device will be described.

A control unit controls a whole of each server and each device. The control unit realizes various kinds of function by reading and executing various kinds of program stored in a storage unit of each server and each device, and is configured of one or a multiple of computing devices (for example, a CPU (central processing unit)).

The storage unit is configured of, for example, an SSD (solid state drive), which is a semiconductor memory, or an HDD (hard disk drive), which is a magnetic disk. Also, the storage unit may be realized by a NAS (network-attached storage) or cloud system that uses a network.

A communication unit carries out communication between a server or a device and another device. Specifically, the communication unit is an interface connected to the network NW, and is configured of, for example, an NIC (network interface card). A communication method may be either wired or wireless, and may be either a LAN (local area network) or a WAN (wide area network), provided that a method whereby communication can be carried out with another device or the like is utilized. For example, the Ethernet (registered trademark) may be utilized, or a mobile communication network such as LTE (Long-Term Evolution) or 5G (5th Generation) may be utilized. Also, communication may carry out with another device via an internet.

An input/output unit carries out an input or output of an instruction or data via an external device, a server, or a communication unit. For example, by a UI (user interface) or an API (application programming interface) being provided by a WEB service, a user or an external device can issue an instruction to a device or a server, or acquire information. Also, an instruction may be issued, or information acquired, by an input/output device (for example, a mouse, a keyboard, a speech input/output device, a display, or a touch panel) being connected directly to a device or a server.

These configurations may be changed as appropriate in accordance with each server and each device. For example, in a case of a mobile terminal device, a storage device is mainly configured of a semiconductor memory.

1.3.1 Ticket Management Server

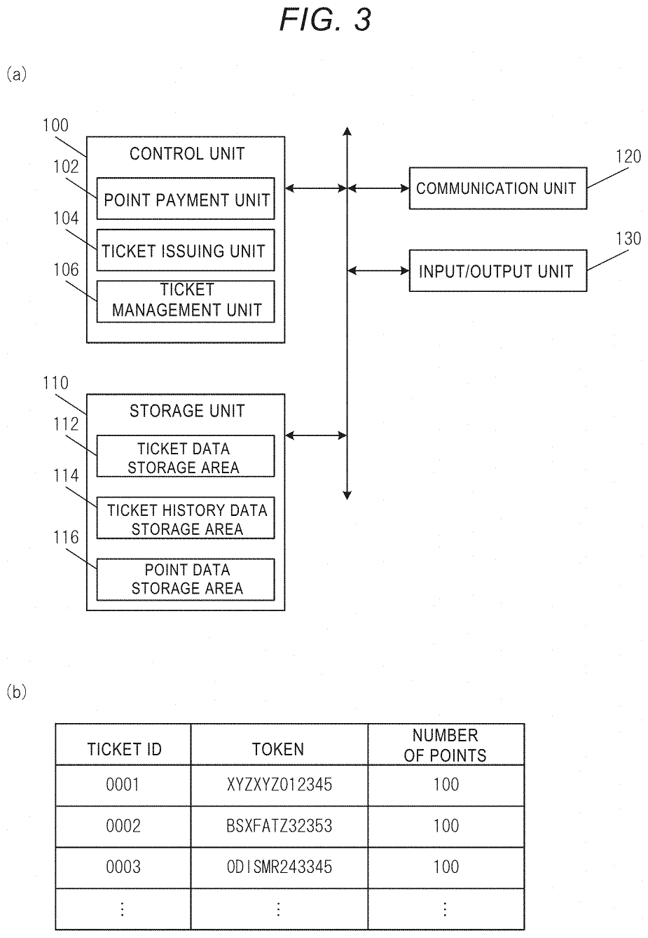

FIG. 3 is a drawing for describing a functional configuration of the ticket management server 10. The ticket management server 10 is configured to include a control unit 100, a storage unit 110, a communication unit 120, and an input/output unit 130.

The control unit 100 functions as a point payment unit 102, a ticket issuing unit 104, and a ticket management unit 106 by reading and executing a program stored in the storage unit 110.

The point payment unit 102 carries out a payment of points in accordance with an instruction from a user. For example, the point payment unit 102 accesses the point management server 20, causes points in a user wallet of the user to increase or decrease or causes points to be transferred to another wallet (a user wallet or a ticket wallet), or causes point data in a point data storage area 116 to increase or decrease. Furthermore, depending on an authority range granted to the ticket management server 10 by the point management server 20, a case wherein points themselves can be increased or reduced, and a case wherein only a wallet having authority can be operated (a remittance to another wallet, that is, a transfer), are conceivable.

The ticket issuing unit 104 carries out a control of issuing a virtual ticket. A process of issuing a ticket will be described hereafter.

The ticket management unit 106 carries out a control of managing an issued ticket. For example, the ticket management unit 106 carries out a process of changing a number of points given to a ticket, or a process of deleting a ticket. These processes will be described hereafter.

A ticket data storage area 112 in which ticket data are stored, a ticket history data storage area 114 in which ticket history data are stored, and the point data storage area 116, in which point data are stored, are secured in the storage unit 110. Storage of point data nay also be entrusted to the point management server 20 or another external system, without providing the point data storage area 116 in the storage unit 110.

Ticket data stored in the ticket data storage area 112 are data relating to a ticket issued by the ticket issuing unit 104. Ticket data are, for example, managed in a ticket wallet for each user. Hereafter, some items of ticket data will be described. In the embodiment, any item of ticket data can be utilized.

(1) First Ticket Data

An example of first ticket data is shown in FIG. 3(b). Ticket ID, which is an identification number for each ticket, a token, which is identification information for uniquely identifying a ticket, and a number of points given (allotted) to the relevant ticket, are stored as ticket data.

A ticket token is preferably uniquely identifiable via a user and the whole ticketing system. That is, by being based on a token, information relating to a user, ticket ID, a number of points given to a ticket, and a service or the like corresponding to the relevant points, can be uniquely identified by each device or system.

(2) Second Ticket Data

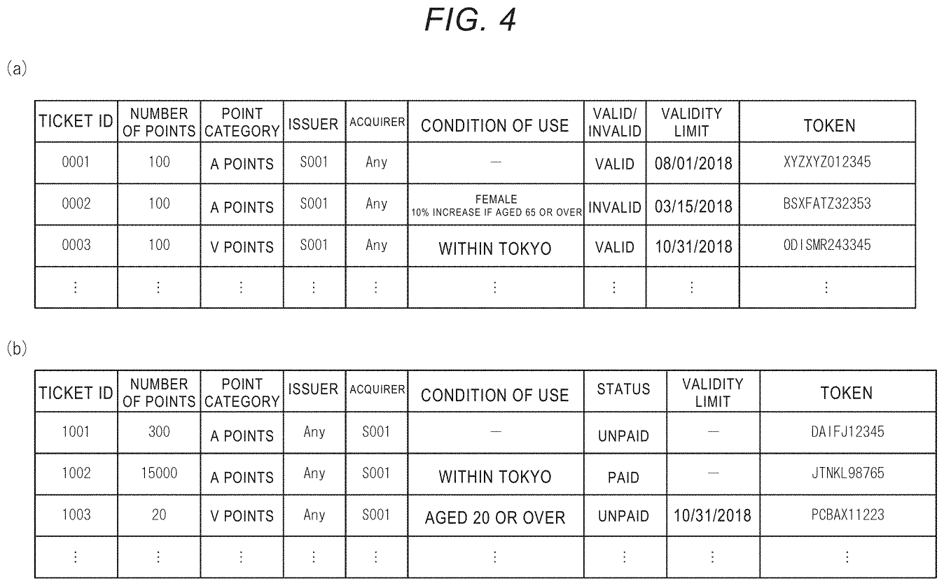

An example of second ticket data is shown in FIG. 4. For example, second ticket data shown in FIG. 4(a) are ticket ID (for example, “0001”), which is an identification number for each ticket, a number of points (for example, “100”) allotted to the relevant ticket, and a point category (for example, “A points”) of the relevant points. This is for identifying a service provider when there are a multiple of service providers providing a point service.

ID (for example, “S001”) of an issuer who has issued the relevant ticket, and a user who can acquire the relevant ticket. “Any” is stored when a user is not specified.

A condition of use of the relevant ticket. Herein, a condition for when a user (consumer) uses a ticket can be stored For example, conditions such as an age group, a gender, a place, and a date and time can be stored as envisaged conditions of use. When a user (consumer) corresponds to a condition, the user can use a ticket.

Information indicating whether the relevant ticket is “valid” or “invalid”. This may be set by the issuer, or may be set automatically in accordance with a condition setting.

A “validity limit” (for example, “08/01/2018”) of the relevant ticket, and a token for uniquely identifying the relevant ticket, are stored.

It is sufficient that necessary information among the heretofore described information is included as appropriate in the ticket data. FIG. 4(a) is mainly tickets in cases wherein an issuer (for example, a producer) transfers points to a recipient (for example, a consumer).

Also, by using ticket data shown in FIG. 4 (b), the ticket data can be utilized in a case wherein an issuer (for example, a producer) acquires points from a recipient (for example, a consumer) (points are transferred from a recipient to an issuer). Specifically, this can be realized by the issuer being “Any” and the acquirer being “S001”. Also, “unpaid” or “paid” may be stored as a status of a ticket.

(3) Third Ticket Data

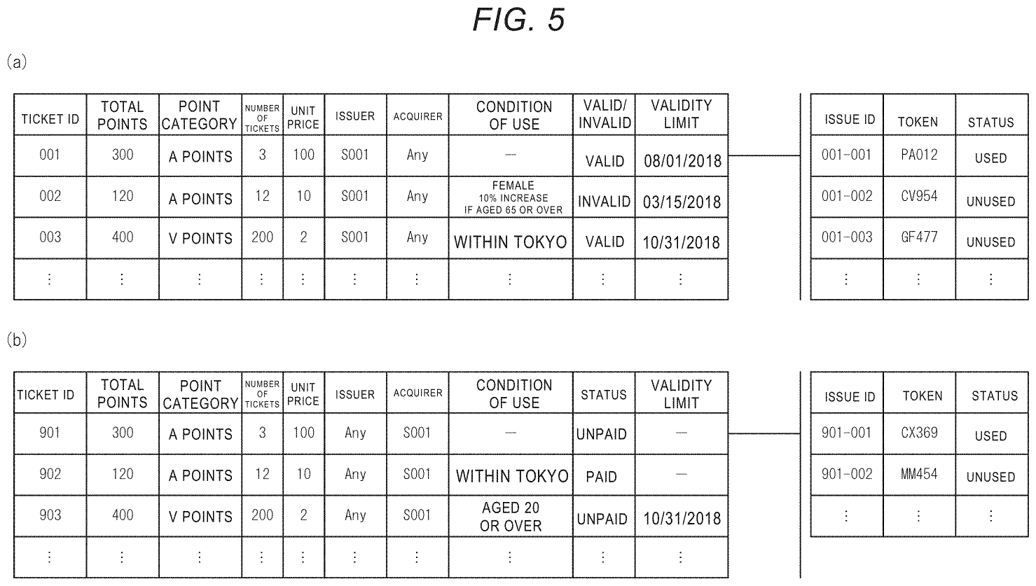

An example of third ticket data is shown in FIG. 5. For example, the third ticket data shown in FIG. 5(a) are such that, unlike the second ticket data, a total number of issued tickets and a unit price of a ticket (point unit price) are stored as ticket data. Also, data relating to each ticket are stored separately.

For example, the table on the left side of FIG. 5(a) shows data relating to total tickets. Also, the table on the right side of FIG. 5(a) shows data relating to each ticket. Hereafter, items (information) included in the ticket data will be described. A description of items (information) the same as the second ticket data shown in FIG. 4 will be omitted.

The total number of tickets and the unit price of each ticket. The number (total number) issued as the relevant ticket, and a number of points per ticket (point unit price), are stored.

Issue ID for each ticket and a token are stored as data for each ticket. Also, a status is stored for each ticket. For example, “used” or “unused” can be stored as a status. Herein, FIG. 5(a) is mainly tickets in cases wherein an issuer (for example, a producer) transfers points to a recipient (for example, a consumer).

For example, by using ticket data shown in FIG. 5(b), the ticket data can be utilized in a case wherein an issuer (for example, a producer) transfers points from a recipient (for example, a consumer), in the same way as the second ticket.

Ticket history data, which are a history of a case wherein a user (for example, a consumer) has used a ticket, are stored in the ticket history data storage area 114. Not only is basic information such as a date and time of use, points, and a user included in data indicating a ticket history (ticket history data), but shop information and product information may also be included, and furthermore, information relating to a location in which the ticket has been used may be included.

Specifically, one or multiple items of information such as a token of a ticket used, the date and time of the ticket being used, the number of points used, the user who has used the ticket, information relating to the product for which the ticket has been used, information relating to the shop at which the ticket has been used, and the place at which the ticket has been used (location information), are stored as necessary as ticket history data.

For example, a case wherein a ticket is appended to a product, and a user uses the relevant ticket, is envisaged. In this case, the user and the place at which the ticket has been used can be extracted for each product by referring to the ticket history data. An analysis of a product user group can be carried out, separately from sales information of the retail outlet, from the extracted data. This is because there are cases wherein the purchaser and the user of the product are different. Various analyses can be carried out by referring to the relevant ticket history data in this way.

The point data storage area 116 is a area in which point data (point data for a ticket) received from the point management server 20 are stored. The point payment unit 102 transfers (pays) points that can be utilized as a ticket from the point management server 20 to the point data storage area 116. Points managed in the point data storage area 116 form a ticket wallet.

Further, when issuing a ticket, the ticket issuing unit 104 causes point data stored m the point data storage area 116, that is, points in an issuer ticket wallet, to decrease. The ticket issuing unit 104 may access the point management server 20, and directly cause points in an issuer user wallet to decrease. Also, the point management server 20 may realize a ticket wallet by separately managing a wallet that can be utilized for a ticket among points in a user wallet.

1.3.2 Point Management Server

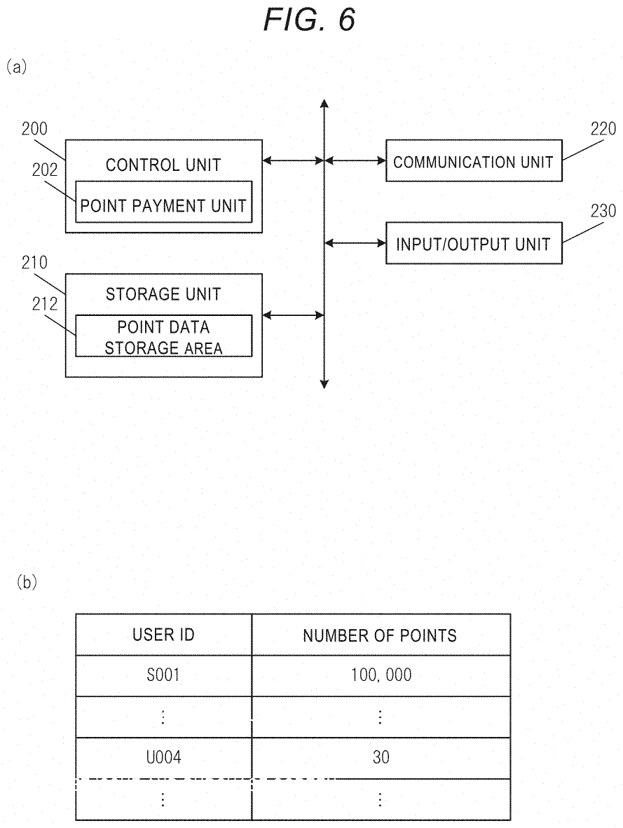

A functional configuration of the point management server 20 will be described, with reference to FIG. 6(a). The point management server 20 is configured to Include a control unit 200, a storage unit 210, a communication unit 220, and an input/output unit 230.

The control unit 200 functions as the point payment unit 202 by reading and executing a program stored in the storage unit 210.

The point payment unit 202 pays point data stored in a point data storage area 212. For example, when a process of purchasing points is carried out by a user via the input/output unit 230, a point balance in a user wallet of the relevant user increases. Also, when there is an instruction to transfer points from a wallet or the point management server 20 to a ticket issuer ticket wallet, the point payment unit 202 transfers a number of points commensurate with the instruction. That is, a point balance in a user wallet of the relevant user decreases.

An area of a point data storage area 212 is secured in the storage unit 210. Point data are stored in the point data storage area 212.

Point data are such that a number of points is stored correlated to user ID, as shown in FIG. 6(b). An area wherein points are managed for each user in this way is generally called a wallet (herein, a user wallet). For example, a point balance (remaining points) of a user wallet with user ID “S001” is “100,000”, as shown in FIG. 6(b).

As heretofore described, point data stored in the ticket management server 10 may also be stored in the point management server 20. That is, it is sufficient that a user wallet (point data) is managed separated into a normal wallet and a ticket issuer wallet.

1.3.3 Management Device

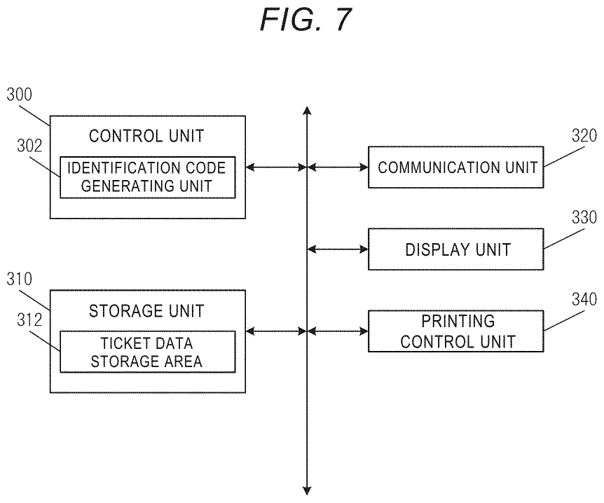

A configuration of the management device 30 will be described, with reference to FIG. 7. The management device 30 is configured to include a control unit 300, a storage unit 310, a communication unit 323, a display unit 330, and a printing control unit 340. The management device 30 is realized by an information processing device such as a computer or a tablet. Also, an existing POS system (point of sales system) may be utilized.

The control unit 300 functions as an identification code generating unit 302 by reading and executing a program stored in the storage unit 310.

The identification code generating unit 302 generates an identification code including a token for identifying a ticket. An identification code may be a two-dimensional code (for example, a QR code (registered trademark), a CP code, or a PDF417), or a combination of a multiple of one-dimensional codes (so-called barcodes). Also, an identification code may be indicated using letters.

An area of a ticket data storage area 312 is secured in the storage unit 310. In order to generate an identification code, the management device 30 acquires ticket data from the ticket management server 10, arid stores the ticket data in the ticket data storage area 312.

The display unit 330 displays various kinds of information, or displays an identification code. For example, the display unit 330 is a display that is provided in a cash register terminal, and which can be visually recognized by a customer. The management device 30 displays an identification code on the display unit 330 (display).

The printing control unit 340 carries out a control of printing an identification code. For example, the printing control unit 340 carries out a control of printing a label on which there is an identification code from a printing device or a multifunctional machine connected to an exterior. Because of this, for example, an issuer can attach the printed label to a product or the like, and distribute the product.

The heretofore described configuration need not necessarily include everything. For example, when a two-dimensional code that is an identification code is not displayed, the display unit 330 is not needed. In the same way, the printing control unit 340 is not needed when not printing.

1.3.4 Terminal Device

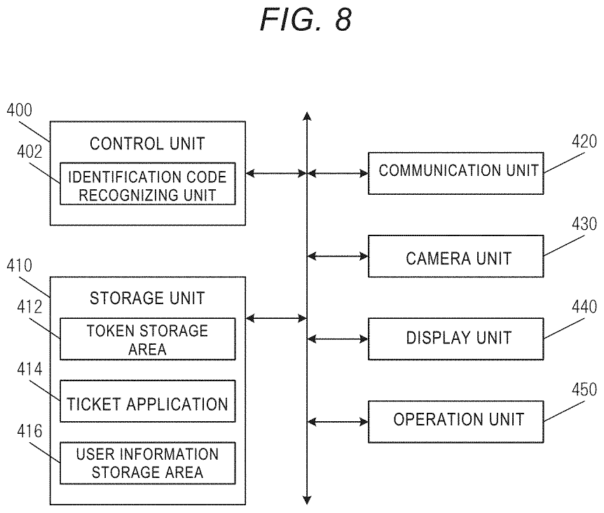

A functional configuration of the terminal device 40 will be described, with reference to FIG. 8. The terminal device 40 is configured to include a control unit 400, a storage unit 410, a communication unit 420, a camera unit 430, a display unit 440, and an operation unit 450. The terminal device 40 is mainly a terminal device utilized by a customer, and is a portable terminal device such as a smartphone or a tablet. The terminal device 40 may also be a computer or the like utilized by a customer.

The control unit 400 functions as an identification code recognizing unit 402 by reading and executing a program stored in the storage unit 410.

The identification code recognizing unit 402 recognizes a token included in an identification code filmed via the camera unit 430, and stores the token in a token storage area 412 of the storage unit 410.

A token stored in the token storage area 412 is transmitted to the ticket management server 10. Because of this, a ticket corresponding to an identification code recognized by the terminal device 40 is identified, and a user can use the ticket.

In addition to the heretofore described token storage area 412, in which a token is 3tored, and a user information storage area 416 being secured, a ticket application 414 is stored in the storage unit 410.

For example, the ticket application 414 may be installed in advance in the terminal device 40, or may be downloaded via the communication unit 420. By starting up the ticket application 414, the control unit 400 can, for example, film an identification code via the camera unit 430, and recognize a token included in the identification code.

Also, the ticket application 414 may manage and store user information relating to a utilizer of the terminal device 40, to be described hereafter, or may acquire positional information relating to the terminal device 40. For example, the ticket application 414 acquires positional information from a positional information acquisition unit (not shown) connected to the terminal device 40, and transmits the positional information to the ticket management server 10. Also, the ticket application 414 may transmit user information and information relating to the terminal device 40 together with the positional information.

The positional information may be acquired by utilizing, for example, a GSNN (global navigation satellite system), or positional information may be acquired by utilizing positional information or the like from an LTE/5G/WLAN (wireless LAN) base station device.

User information, which is information relating to a user, is stored in the user information storage area 416. User information is information relating to a utilizer of the terminal device 40. For example, user ID for when utilizing the system and information relating to a terminal device (for example, an IP address (internet protocol address), a MAC address (media access control address), and an IMSI (international mobile subscriber identity), which is a SIM card (subscriber identity module card) identification number,) are stored. Information relating to a terminal device may be acquired from each device, rather than being stored in the user information storage area 416.

Also, user information may additionally include information input by a user, such as a residential area, an age, a gender, an occupation, or a hobby, or information that can be acquired, such as a place often visited or a purchase history.

User information may be stored in the user information storage area 416, or may be managed and stored by the ticket application 414. Also, information relating to a multiple of users maybe stored in accordance with a login switching process by a user. Also, the information may be managed by the cloud, and acquired by the ticket application 414 when logging in to the system.

The camera unit 430 is a filming device incorporated in a terminal device. An external filming device may be utilized as the camera unit 430.

The display unit 440 displays various kinds of information to a user. The operation unit 450 receives an operational input from a user. The display unit 44 0 and the operation unit 450 may be configured integrally as a touch panel.

1.4 Process Flow

1.4.1 Overall Flow

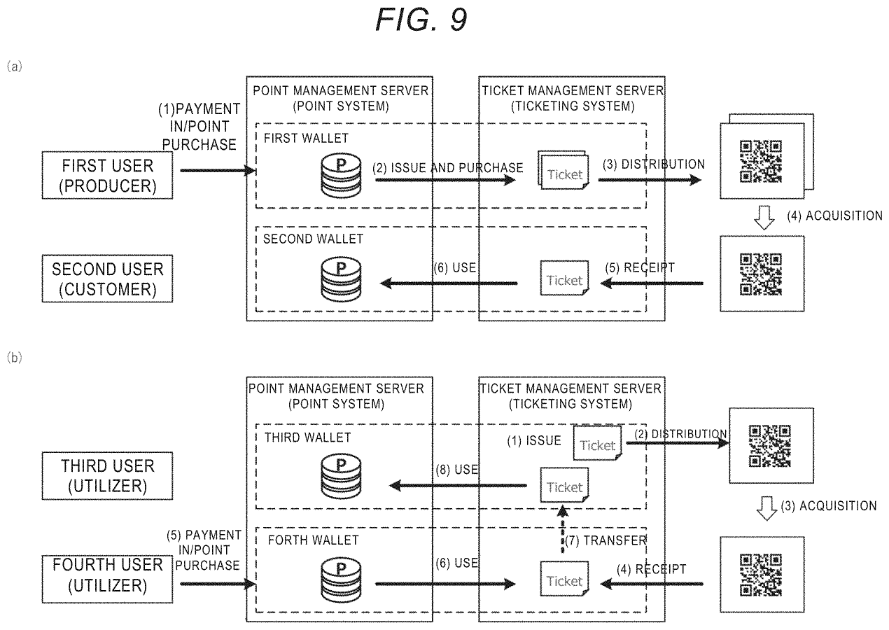

An overall flow of the embodiment will be described, with reference to FIG. 9. FIG. 9(a) is a working example illustrating a transfer of points from a wallet of a first user (for example, a producer), who is a ticket issuer/sender, to a wallet of a second user (for example, a customer or a consumer), who is a recipient.

Firstly, the first user purchases (charges) points for a user wallet of the first user (a first wallet) ((1) in FIG. 9(a)). By so doing, the number of points (point balance) in the user wallet of the first user increases.

Continuing, the first user issues (purchases) a ticket by utilizing points in the user wallet of the first user ((2) in FIG. 9(a)). At this time, the balance in a ticket wallet increases by an amount equivalent to the issued ticket.

Details will be described hereafter, but when a ticket is issued at this time, the balance in the user wallet need not decrease at this point, or alternatively, may be caused to decrease once at this point.

After transferring points to a ticket issue wallet (for example, a wallet managed by a user account prepared for the ticket management server 10 in the point management server 20) among user wallets, the first user may issue a ticket by utilizing points in the ticket issue wallet.

The first user generates an identification code based on the issued ticket, and outputs the identification code ((3) of FIG. 9(a)). By so doing, the first user can distribute the ticket. Ticket distribution is carried out by, for example, printing a two-dimensional code in such a way that the two-dimensional code can be recognized by a terminal device of the second user. The printed two-dimensional code may be attached to a product, or may be distributed as a printed ticket. Also, the two-dimensional code may be displayed on a display or the like of each device.

The second user, for example, films the identification code (two-dimensional code) using the camera unit 430 of the terminal device 40. That is, the second user acquires the identification code ((4) in FIG. 9(a)). Further, the terminal device 40 recognizes a token from the filmed identification code. Because of this, the ticket is identified from the recognized token. That is, the second user can receive the ticket corresponding to the recognized token from the ticket management server 10 (the ticketing system) ((5) in FIG. 9(a)). By so doing, the balance (number of tickets) in a ticket wallet of the second user increases. Together with this, a ticket managed by the first user is deleted from the ticket wallet of the first user. That is, the balance in the ticket wallet of the first user decreases by an amount equivalent to the deleted ticket.

To facilitate the description, a token for identifying a ticket and an identification code are described separately, but a token may also be used as it is as an identification code. That is, as a token and an identification code are conceptual, a ticket may be identifiable based on an identification code.

When the second user uses a ticket, points in a user wallet of the second user (a second wallet) increase by an amount equivalent to points allotted to the ticket ((6) in FIG. 9(a)). That is, the balance (number o; points) in the user wallet of the second user increases. Together with this, the relevant ticket is deleted from the ticket wallet of the second user. Ticket use may be carried out together with the heretofore described ticket reception of FIG. 9(5).

By a ticket being used in a transfer of points in this way, a ticket being issued by the first user, who is a transfer source, is deleted, and the point balance in the user wallet of the second user, who is a transfer destination, increases. A timing of a point balance in a wallet of a transfer source decreasing and a timing of a point balance in a wallet of a transfer destination increasing being different, unlike a case of a normal payment or transfer process, is a characteristic of the embodiment.

This means that by the first user issuing a ticket in advance, the ticket can be managed separately from a user wallet balance. For example, the number of points allotted to a ticket can be changed, or the ticket can be invalidated, even after the ticket is issued.

Also, there are tickets that can be used only once, and those that can be used multiple times. For example, a ticket may be usable multiple times provided that this is within the ticket wallet balance, and within the ticket wallet credit range. For example, a method of utilization when a producer appends a ticket to a product and sells the product, in which multiple users use the same ticket is conceivable.

In this way, a user can gain points by utilizing a ticket. The above description is such that when a ticket is used, the second user gains the points allotted to the ticket. That is, a ticket being used and a user gaining points are synonymous.

Also, the system can also be utilized when paying and for a simple point transfer. FIG. 9(b) illustrates a working example wherein points are transferred to a user wallet of a third user (a third wallet) from a user wallet of a fourth user (a fourth wallet).

Firstly, the third user issues a ticket indicating the number of points the third user wishes to receive in the ticket management server 10 ((1) in FIG. 9(b)). Also, the third user outputs an identification code (two-dimensional code) including a token that identifies the issued ticket, and distributes the ticket ((2) in FIG. 9(b)).

The fourth user, for example, reads and films the output two-dimensional code using the camera unit 430 of the terminal device 40, thereby recognizing the token included in the two-dimensional code. That is, the fourth user acquires the ticket distributed by the third user ((3) in FIG. 9(b)). Further, the fourth user receives the ticket corresponding to the token recognized from the ticket ((4) in FIG. 9(b)).

Herein, when the fourth user uses the ticket, the number of points indicated by the ticket is subtracted from the points in the user wallet of the fourth user. Various methods are conceivable as an arrangement for carrying out the point subtraction, but as an example, the fourth user purchases (charges) points for the user wallet of the fourth user ((5) in FIG. 9(b)). Further, by the fourth user using the ticket, points are transferred from the user wallet of the fourth user to a ticket wallet equivalent to the ticket, and the balance in the ticket wallet decreases ((6) in FIG. 9(b)).

Further, the ticket of the fourth user is transferred to the third user ((7) in FIG. 9(b)). Specifically, the points in the ticket wallet of the third user increase by a number of points equivalent to the points subtracted from the ticket wallet of the fourth user. Further, by the third user using the ticket, the point balance in the user wallet of the third user increases ((8) in FIG. 9(b)). In this way, the wallet balance of the third user increases by a number of points equivalent to the number subtracted from the wallet of the fourth user. As the third user can confirm that a payment has been carried out using ticket information, the timing of points being received in the wallet of the third user need not be synchronized with an individual payment.

By the system being utilized in this way, a transfer of points between wallets can be carried out easily.

For example, when the third user is a producer, the third user allots an identification code corresponding to a ticket to a product. This means that by a consumer who is the fourth user using the ticket, points equivalent to the price of the product are transferred from the user wallet of the fourth user to the user wallet of the third user. That is, the system can be utilized for payment when purchasing a product.

1.4.2 Ticket Issuing Process

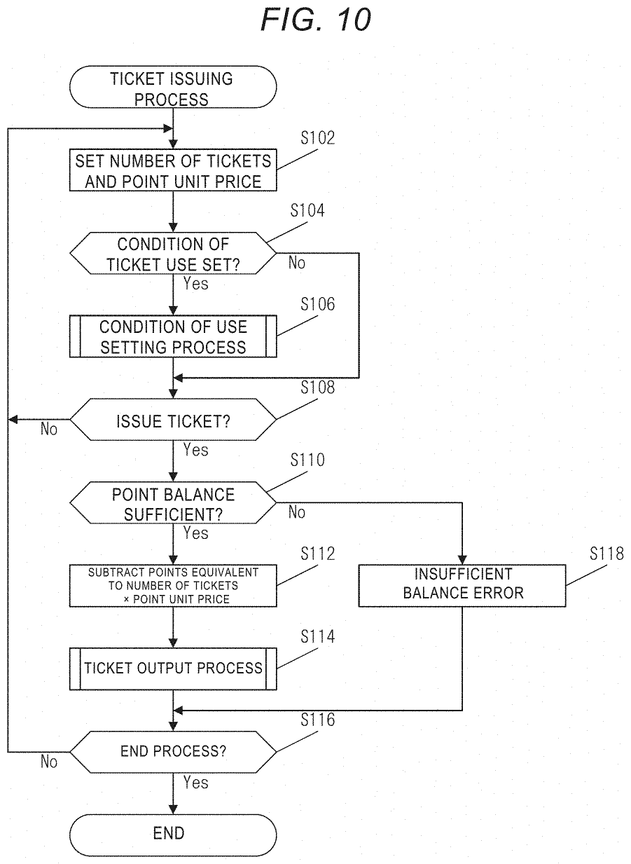

A ticket issuing process will be described, with reference to FIG. 10. The ticket issuing process is a process mainly executed by the ticket management server 10. For example, the ticket issuing process is executed by the ticket management server 10 by the ticket management server 10 being accessed via the Web from the management device 30, and an operation being carried out. The description will be given assuming that when the process is executed, payment has been made in advance into a user wallet.

The control unit 100 (ticket issuing unit 104) sets a number of tickets and a unit price (step S102). Specifically, an issuer operates the management device 30, and accesses a ticket issue screen of the ticket management server 10 provided on the Web. The issuer inputs, for example, a number of tickets to be issued and a ticket point unit price on the screen.

Continuing, the control unit 100 (ticket issuing unit 104) executes a condition of use setting process when a condition of ticket use has been set by the issuer (step S104: Yes, proceed to step S106).

Various conditions under which a user (for example, a recipient) can use a ticket can be set as a condition of ticket use. For example, various conditions of use, such as a place (location) in which the ticket is used, a time limit, a user age, a gender, whether or not the ticket can be used repeatedly and a maximum number of uses, or a maximum number of uses for each user, can be set.

To describe specific examples of a condition of use, for example, an area in which the ticket can be used can be limited to a store A, or limited to the Kanto region. Also, a user age can be limited to under 20, use can be limited to once a day, or the number of times a user can use the ticket can be limited to three.

When the number of tickets to be issued, the point unit price, and the condition of use are set, and an instruction to execute a ticket issuing process is given (step S108: Yes), the control unit 100 (ticket issuing unit 104) confirms whether or not there is a sufficient point balance in a user wallet of the issuer (step S110).

Herein, an issuer user wallet in the embodiment may be a whole user wallet of the issuer managed by the point management server 20, or may be a ticket issue wallet managed by the ticket management server 10 or the point management server 20.

When the point balance is insufficient when compared with points calculated from the number of tickets to be issued and the unit price, an “insufficient balance error” occurs, and the process is ended (step S110: No, proceed to step S118).

Various processes are conceivable as a process when an insufficient balance error occurs. For example, the control unit 100 may end the process by carrying out a warning display, or may induce to purchase (pay in) points, or may induce to add points in order to increase points for tickets. Also, the control unit 100 may induce a change in the number of tickets to be issued or the unit price.

When the point balance in the issuer wallet is appropriate, the control unit 100 subtracts points equivalent to the number of tickets to be issued multiplied by the unit price of points allotted to the tickets from the user wallet (step S112). The control unit 100 stores the ticket in the ticket data storage area 112. That is, the control unit 100 outputs (issues) the ticket (step S114). By so doing, the ticket balance (the point balance equivalent to the number of tickets) increases in the ticket wallet.

When the process does not end, the control unit 100 executes the process again from step S102 (step S116: No, proceed to step S102).

1.4.3 Ticket Management Process

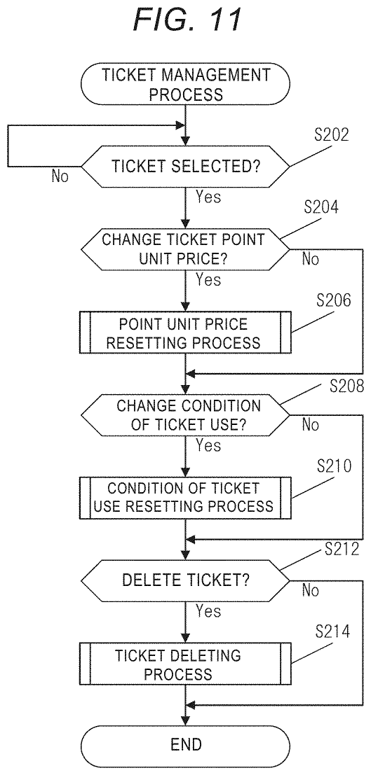

A process of managing an issued ticket will be described, with reference to FIG. 11. Firstly, a ticket to be changed or deleted is selected by a user (for example, an issuer) (step S202). Herein, there nay be one selected ticket, or there may be a multiple. Also, tickets may be displayed as a list and the user caused to make a selection, or a condition may be set, tickets displayed narrowed down (for example, narrowed down to a date of issue, a condition of use, or a recipient), and the user caused to make a selection.

When a ticket is selected, the ticket management unit 106 (control unit 100) executes a process of managing the ticket. For example, when the unit price of points allotted to the ticket is to be changed, the ticket management unit 106 (control unit 100) executes a process of resetting the point unit price (step S204: Yes, proceed to step S206).

The process of resetting the point unit price is a process of resetting the number of points allotted to the ticket. The number of points for each ticket is not, for example, included in a printed ticket on which an identification code is printed. Consequently, the number of points can be changed by the ticket management server 10.

A conventional system is such that an issued ticket or allotted points cannot subsequently be changed. In the embodiment, a point unit price can be changed even in the case of an issued ticket.

Also, when the condition of ticket use is to be changed, the ticket management unit 106 (control unit 100) executes a process of resetting the condition of ticket use (step S208: Yes, proceed to step S210).

The process of resetting the condition of ticket use is such that, for example, a place in which the ticket can be used can be added or deleted. Also, as a condition of use, an age group is changed, or a condition for a number of points allotted is changed in accordance with date and time.

Also, when a ticket is to be deleted, the ticket management unit 106 (control unit 100) executes a ticket deleting process (step S212: Yes, proceed to step S214).

The ticket deleting process is such that a process of deleting a selected ticket is executed. By the ticket being deleted, for example, allotted points may be returned to the user wallet of the issuer.

Also, a condition of use can also be set by these processes being combined. For example, a process whereby the price of points allotted is raised may be carried out when a best-by date of a product approaches. For example, adopting the best-by date of a product as an expiry date of the ticket, setting may be carried out in such a way that 30 points are allotted when there are two to three months until the expiry date, and 50 points when there are one to two months.

1.4.4 Payment Process

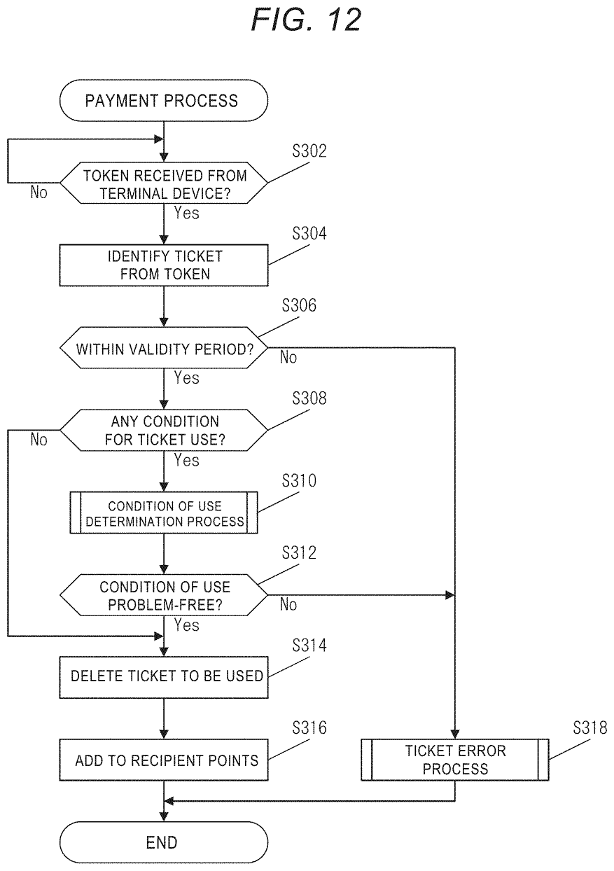

A payment process will be described, with reference to FIG. 12. The ticket management unit 106 (control unit 100) receives a token from the terminal device 40 via the communication unit 120 (step S302). The ticket management unit 106 (control unit 10C) identifies a ticket from the received token (step S304).

The point management server 20 receives not only a token but also, as necessary, other information from the terminal device 40. For example, the point management server 20 receives one or a multiple of a user ID (information for identifying a wallet of a recipient), positional information relating to the terminal device 40, and other information relating to a user (various items of information such as a user age group, gender, address, and shopping area set in the ticket application 414) as information relating to a user utilizing the terminal device 40. It is preferable that at least user ID is included in the received user information. Also, simply information relating to the terminal device 40 (identification ID for identifying the terminal device 40 (a telephone number, an IMEI (international mobile equipment identity), positional information, and the like) may be received rather than user information. Consequently, even when simply referred to as user information, information relating to the terminal device 40 (terminal information) may be received together with the user information, or may be received instead of the user information.

The ticket managing unit 106 (control unit 100) determines whether or not the ticket identified in step S304 is within a period of validity (step S306). When an expiry date is included in the ticket data, the ticket managing unit 106 determines whether or not a current date and time (the time at which the ticket is used) has exceeded the expiry date.

When the ticket is not within the period of validity, the ticket management unit 106 (control unit 100) executes a ticket error process, as the allotted points cannot be acquired (step S306: No, proceed to step S318).

The ticket error process of step S318 is a process carried out when a ticket cannot be used. For example, error information is transmitted to the terminal device 40. Because of this, the terminal device 40 can carry out an error display. Also, there is a case in which the ticket management server 10 executes a process of invalidating the ticket, a case in which the ticket management server 10 ends the payment process as an error without carrying out any particular process (that is, without deleting a ticket to be described hereafter), and the like.

When the ticket is within the period of validity, the ticket management unit 106 (control unit 100) determines whether or not a condition of use has been further set (step S306: Yes, proceed to step S308). That is, the ticket management unit 106 (control unit 100) determines whether or not a condition of use is included in the ticket data.

When a condition of use has been set for a ticket (step S308: Yes), the control unit 100 executes a condition of use determining process (step S310). Herein, the condition of use determining process is a process of determining whether or not a user (for example, a customer or consumer who is a recipient that receives points) corresponds to the condition for using the ticket. For example, when the age of the user corresponds to the condition of ticket use, the control unit 100 determines that the condition of ticket use is problem-free (step S312: Yes). Other than this, when information relating to a location in which the ticket is to be used is appended, the control unit 100 determines that the condition of use is problem-free when the location in which the ticket is to be used corresponds with the location information, or is in a vicinity thereof. A condition of use set in the heretofore described ticket issuing process is applied as the condition of use.

Meanwhile, when the user does not correspond to the condition of use, the control unit 100 determines that there is a problem with the condition of use, and executes a ticket error process (step S318).

When determining that there is no condition of use for the ticket (step S308: No) or determining that the condition of ticket use is problem-free (step S312: Yes), the ticket management unit 106 (control unit 100) deletes the ticket to be used (step S314). Also, the point payment unit 102 (control unit 100) adds the points allotted to the ticket to the ticket wallet of the recipient (step S316). That is, the balance of points managed by the ticket wallet of the recipient increases by an amount equivalent to the points allotted to the ticket. In this case, the points may also be added to the user wallet of the recipient.

Confirmation may be carried out once with the user when the ticket is used. For example, confirmation of whether or not the ticket is to be used is carried out from the ticket management device 10 to the terminal device 40 after step S312. The process from step S314 onward is executed by information that the ticket is to be used being received from the terminal device 40.

Also, a timing of using the ticket may be confirmed once with the user (terminal device 40). For example, the control unit 100 receives a token in step S302, and identifies a ticket from the token in step S304. At this point, information relating to the identified ticket is transmitted once to the terminal device 40.

Subsequently, the ticket management device 10 receives information indicating that the ticket is to be used from the terminal device 40. At this tine, the ticket management device 10 (control unit 100) may receive user information and/or terminal information, or the like, from the terminal device 40 together with the information indicating that the ticket is to be used. Also, the ticket management device 10 (control unit 100) may take a receiving of user information and/or terminal information from the terminal device 40 to be information indicating that the ticket is to be used.

By ticket information being transmitted once to the terminal device in this way, the terminal device 40 can use the ticket after confirming information relating to the ticket (for example, the number of points allotted or a condition of use).

1.4.5 Process in Terminal Device

Continuing, a process in the terminal device 40 will be described. The terminal device 40 is configured in such a way that the ticket application 414, which can utilize the system, is installed and can be executed. The ticket application 414 may be installed in advance, or may be installed subsequently. Also, the ticket application 414 may be realized by a Web service, or the like, provided by accessing a website from the terminal device 40.

The control unit 400 of the terminal device 40 acquires a token from, for example, an identification code (for example, a two-dimensional code) filmed using the camera unit 430, or an identification code acquired using the communication unit 420 (for example, NFC (near-field communication)). Further, the terminal device 40 transmits the token to the ticket management device 10.

The following three methods are conceivable as a method for the terminal device 40 subsequently using the ticket.

(1) Use the Ticket as it is when the terminal device 40 transmits the token to the ticket management device 10, the ticket is used as it is. In this case, when the token is transmitted and there is no problem with a condition of use or the like, the points of the user corresponding to the terminal device 40 increase. That is, the user can gain the points allotted to the ticket by reading the identification code.

(2) Execute a Confirmation Process when the Ticket is Used

The terminal device 40 receives a signal from the ticket management server 10 confirming whether or not the ticket is to be used at a timing of using the ticket. The terminal device 40 displays a display screen inducing confirmation based on the confirmation signal. When an instruction to use the ticket is input from a utilizer, the terminal device 40 transmits a response (acknowledgement) signal to the ticket management server 10. Because of this, the points of the user corresponding to the terminal device 40 increase. That is, the user can gain the points allotted to the ticket by reading the identification code and carrying out a confirmation operation. Because of this, the user can gain the points (use the ticket) at an arbitrary timing.

(3) Execute a Process when Confirming the Ticket

The terminal device 40 receives ticket information from the ticket management server 10. The terminal device 40 displays a display screen including the ticket information (for example, the number of points allotted, a business, or a condition of use). When an instruction to use the ticket is input from a utilizer, the terminal device 30 transmits a response (acknowledgement) signal to the ticket management server 10. Because of this, the points of the user corresponding to the terminal device 40 increase. Furthermore, a confirmation process may be executed in the terminal device 40 when the ticket is used, as described in (2). That is, the user can confirm the ticket information corresponding to the identification code by reading the identification code. Further, the user can gain the points allotted to the ticket (use the ticket) by carrying out a confirmation operation.

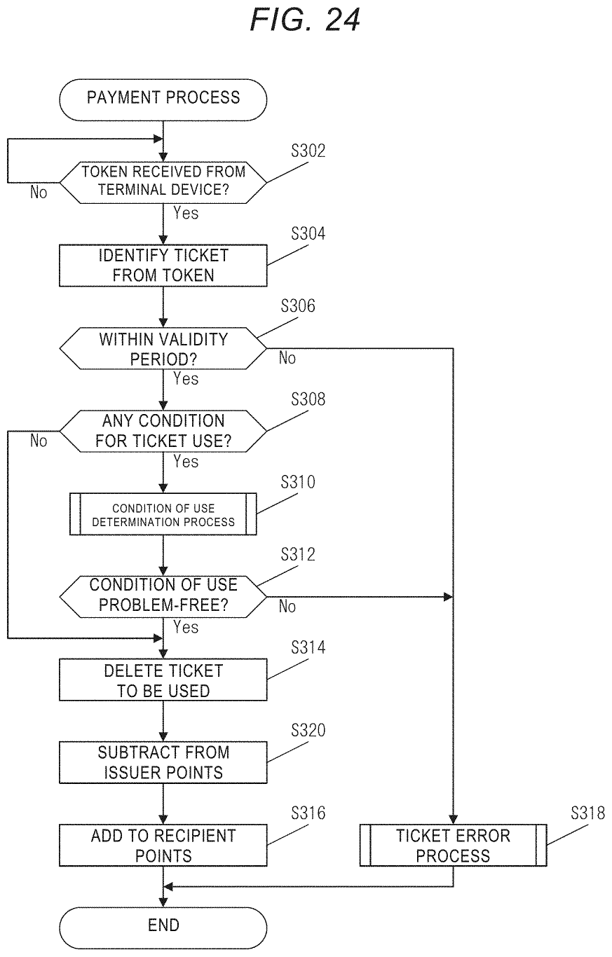

(4) Transmit the ticket at an arbitrary timing On acquiring a token, the terminal device 40 stores the token in the token storage area 412. Further, the user can acquire the number of points allotted to the ticket by using the ticket in the terminal device 40 at an arbitrary timing. Specifically, a token of a ticket to be used is transmitted from the terminal device 40 to the ticket management server 10. The ticket management server 10 executes the process in FIG. 24 from step S306 based on the received token.

### 1.5 OPERATION EXAMPLES

### 1.5.1 First Operation Example

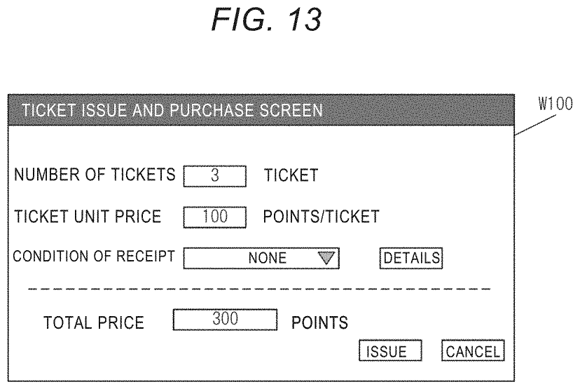

An operation example will be described, with reference to a screen example. FIG. 13 is an example of a display screen W100 displayed in the management device 30 when a user accesses the point management server 20 via the Web. Although the management device 30 is displaying the screen, the screen is a display screen generated by the point management server 20, and may be displayed by any device.

Input fields in which a number of tickets (for example, “3”) and a ticket unit price (for example, “100” points/ticket) can be input are provided on the display screen W100. A user (issuer) inputs the number of tickets and the ticket unit price in the input fields. Also, the user (issuer) can input a “condition of receipt” as a user condition. A total price of issued points (for example, “300” points) is displayed on the display screen W100.

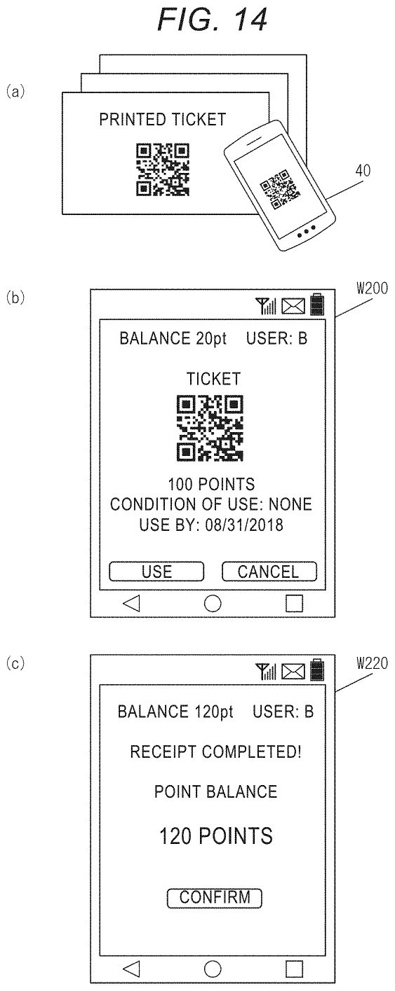

FIG. 14(a) is a drawing showing a state wherein a two-dimensional code generated based on a token has been printed as a printed ticket. A user (for example, a recipient such as a customer or a consumer) films the two-dimensional code using the camera unit 4 30 of the terminal device 40. The identification code recognizing unit 402 (control unit 400) recognizes a token from the filmed two-dimensional code.

FIG. 14(b) is an example cf a display screen W200 on which a ticket that can be acquired in the terminal device 40 is displayed. That is, the terminal device 40 transmits a token recognized from a filmed two-dimensional code to the ticket management server 10. The terminal device 40 transmits user information or terminal information to the ticket management server 10 together with the token.

The ticket management server 10 identifies a ticket from the token, and transmits information relating to the identified ticket (necessary information from among the ticket data) to the terminal device 40. Because of this, information relating to the ticket to be used this time is displayed together with a current point balance in the terminal device 40. At this time, the number of points allotted to the ticket (the number of points obtained by using the ticket), a condition of use, and a ticket expiry date may be displayed.

Information displayed in the terminal device 40 may be stored and displayed by the terminal device 40 as necessary. Also, the terminal device 40 may acquire and display information stored by the ticket management server 10 or the point management server 20. Also, the display screen W200 may be generated by the terminal device 40, or may be generated by the point management server 20 and displayed in the terminal device 40.

When a display screen is generated and stored by the terminal device 40, the ticket management server 10 transmits necessary information from among the ticket data, as heretofore described. When a display screen is generated by the ticket management server 10, the ticket management server 10 generates display screen data (for example, XML or HTML data), and transmits the data to the terminal device 40.

“Use” being selected by the user in the state of FIG. 14(b) results in a display screen W220 of FIG. 14(c). The matter that the ticket has been used by the user, and the point balance has increased, is displayed on the display screen W220 of FIG. 14(c). Also, the user point balance of the user is also displayed, with the point balance increasing compared with that in FIG. 14(b).

A timing of user information and/or terminal information being transmitted from the terminal device 40 may be a timing of the ticket being used. That is, at first only a token is transmitted from the terminal device 40 to the ticket management server 10. Further, user information or terminal information may be transmitted at a timing of the terminal device 40 using the ticket.

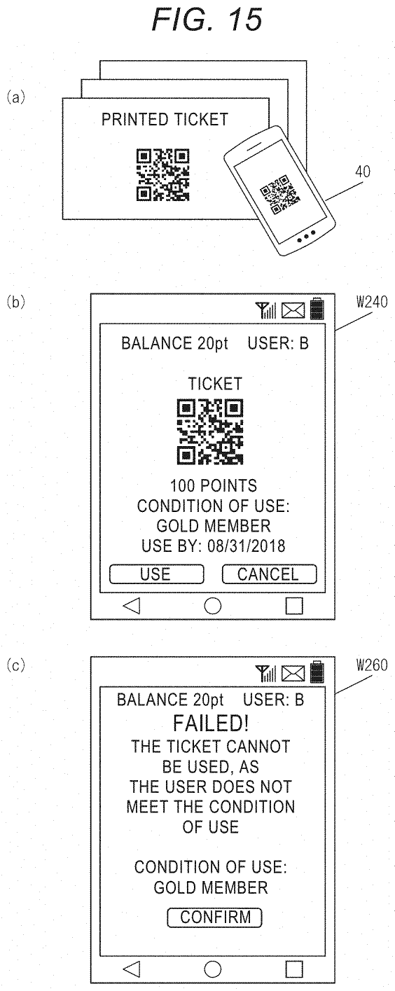

FIG. 15 is a drawing illustrating a case wherein a user has failed in using an acquired ticket. Firstly, in FIG. 15(a) , the terminal device 40 recognizes a token by filming a two-dimensional code. FIG. 15(b) is a display screen W240 wherein a ticket is identified based on the recognized token, and information relating to the ticket is displayed.

Herein, “gold member” is displayed as a condition of ticket use on the display screen W240 of FIG. 15(b). However, when the user using the ticket is not a gold member, there is a shift to FIG. 15(c). A display screen W260 of FIG. 15(c) is a display screen for when a user fails in using a ticket. The matter that the user does not meet the condition of use set for the ticket is displayed on the display screen W260. That is, the user cannot use the ticket.

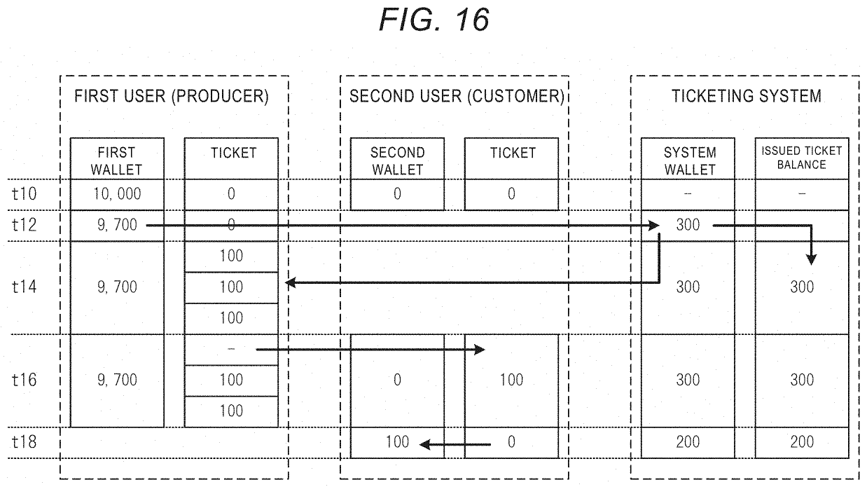

A concept of points increasing or decreasing in this operation example will be described, with reference to FIG. 16. FIG. 16 chronologically shows circumstances under which points are transferred from a first user (for example, a producer who is an issuer) to a second user (for example, a customer who is a recipient).

A user wallet of the first user (a first wallet) , a user wallet of the second user (a second wallet) , and a temporarily utilized system wallet in FIG. 16 are stored in the point system (the point data storage area 212 of the point management server 20). Also, ticket information relating to the first user and ticket information relating to the second user are stored in the ticketing system (the ticket data storage area 112 of the ticket management server 10). Also, an issued ticket balance is managed by the ticket management server 10.

The first user issues a ticket by utilizing points in the wallet of the first, user (the first wallet). Herein, three tickets to which “100” points are allotted are issued. Firstly, the balance in the first wallet is “10,000” points (t10). On the tickets being issued at this point, “300” points are transferred from the first wallet to the system wallet (t12).

Continuing, three tickets to which “100” points are allotted are issued. At this time, the issued ticket balance becomes “300” (t14). t12 and t14 may be processed at practically the same timing, or may be processed as needed.

Continuing, the second user acquires one of the issued tickets. Further, when the second user uses the ticket, the point balance in the second wallet increases by “100”. Together with this, one ticket of the first user is deleted.

Specifically, the balance in the ticket wallet of the second user increases by a ticket to which “100” points are allotted. Also, one ticket to which “100” points are allotted is deleted from the ticket wallet of the first user (t16).

Herein, when the second user uses the ticket, “100” points are transferred from the system wallet to the user wallet of the second user (the second wallet), and the balance in the second wallet increases by “100”. Also, the balance in the ticket wallet of the second user becomes “0” (t18). t16 and t18 may be processed at approximately the same timing, or may be processed as needed.

Herein, the issued ticket balance decreases by “100” points, becoming “200” points. A case wherein the system wallet holds points of the same price as the issued ticket balance as reserve points has been described here, but in a case wherein there is no need to be concerned about holding reserve points, the balance may become “0” at the stage at which the ticket is issued. That is, when tickets equivalent to the balance in the system wallet can be issued, the balance, for example, becomes “0” from t14 onward.

### 1.5.2 Second Operation Example

Continuing, a second operation example will be described. The second operation example is an operation example wherein points are transferred from a wallet of a second user (a customer) to a wallet of a first user (a producer).

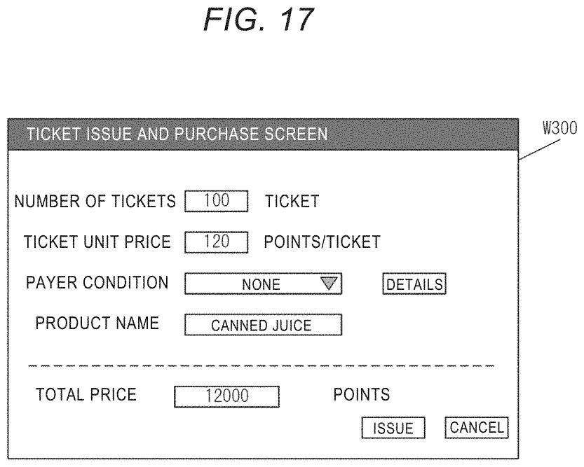

FIG. 17 is an example of a display screen W300 displayed by the management device 30, replacing FIG. 13. A number of tickets to be issued and a ticket unit price can be set on the display screen W300. Together with this, a payer condition can be set. The payer condition can be set in the same way as a user condition, but because of this, the second user can set a payment condition.

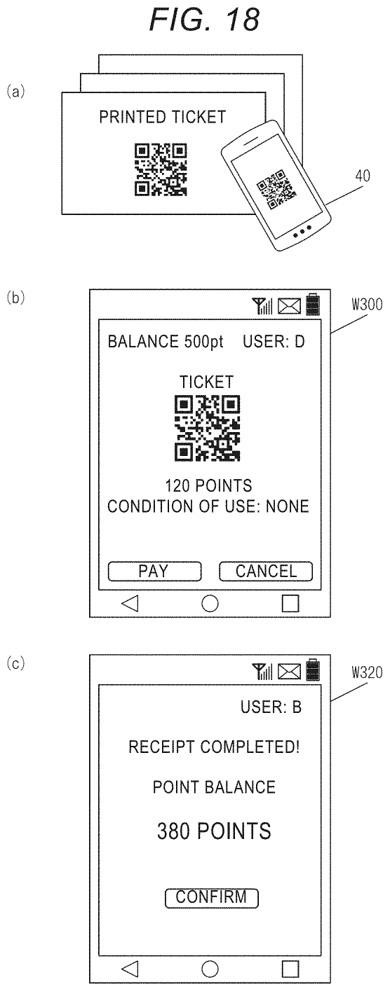

In FIG. 18, points are transferred from the second user to the first user by utilizing the system. As shown in FIG. 18(a), a two-dimensional code printed on a printed ticket is filmed by the terminal device 40, and a token is recognized.

FIG. 18(b) is an example of the display screen W300 displayed in the terminal device 40. Information relating to a ticket corresponding to the recognized token is displayed on the display screen W300. Herein, unlike the first operation example, a number of points to be paid by the second user is displayed.

FIG. 18(c) is an example cf a display screen W320 to which a shift is carried out when the second user selects “pay”. The display screen W320 is such that the point balance has decreased by an amount equivalent to the number of points paid compared with that at the time of the display screen W300.

### 1.5.3 Third Operation Example

A third operation example is an operation example wherein no system wallet is utilized. That is, although the operation is described by utilizing a system wallet in FIG. 16, the issued ticket balance of each user may be caused to increase or decrease directly. For example, when three tickets “100” of the first user are issued from the timing of t1O, a shift to t14 may be carried out.

Also, at t16 and t18, a ticket of the first user is acquired and used by the second user. At these timings, tickets of the first user to which “100” points are allotted decrease, tickets of the second user to which “100” points are allotted increase (t16), and the balance in the user wallet of the second user increases by “100” (t18).

With regard to timings of the second user acquiring and using the ticket too, the balance in the ticket wallet of the second user may increase once, or the balance of the user wallet of the second user may increase directly.

1.6 Advantages

By utilizing the ticketing system of the embodiment in this way, a transfer of points between user wallets can be carried out easily and flexibly. That is, the price of points allotted to a ticket can be increased or reduced, and a ticket expiry date can be set, whereby carrying out a transfer of points between wallets easily and flexibly can be realized.

With existing point systems, allotting points at a time of payment is common. In the embodiment, points can be allotted without being restricted to payment.

Also, by utilizing a ticket, points can be transferred (distributed) without identifying a user. Furthermore, a point distributor (for example, a producer) can ascertain who has used a ticket (received points) using information from when the ticket is used.

Also, payment can be carried out by using the same system as the system for distributing points. That is, all services can be provided by one system, without replacing with another gift coupon or utilizing other payment means.

Also, points allotted to a ticket can subsequently be caused to change. Because of this, higher points can be allotted when a best-by date approaches, allotted points can be increased for the duration of a campaign only, and the like.

Also, a condition of receipt and a condition of use can be restricted. For example, by limiting to an establishment using positional information, a ticket that is used only within the establishment can be issued.

Also, a history of ticket use or a history of point transfer can be acquired. For example, by positional information being included in a history, a sales analysis or the like based on a place used by a customer can be carried out. Also, as the history is separated from payment, an appropriate history can be acquired even when a purchaser and a user are different.

By adopting asynchronization by separating transaction unit management and point transmission/point reception in this way, a payment process and a point process can be carried out separately. Because of this, point management and transfer flexibility can be realized. Also, a point service more varied and advanced than before can be realized.

2. Second Embodiment

A second embodiment will be described. In the second embodiment, a description will be given of an embodiment such that rather than points being deducted from a wallet of an issuer when a ticket is issued, the points are processed as debit points. In the embodiment, only differences from the first embodiment will be described, and a description of common portions will be omitted due to being the same as in the first embodiment.

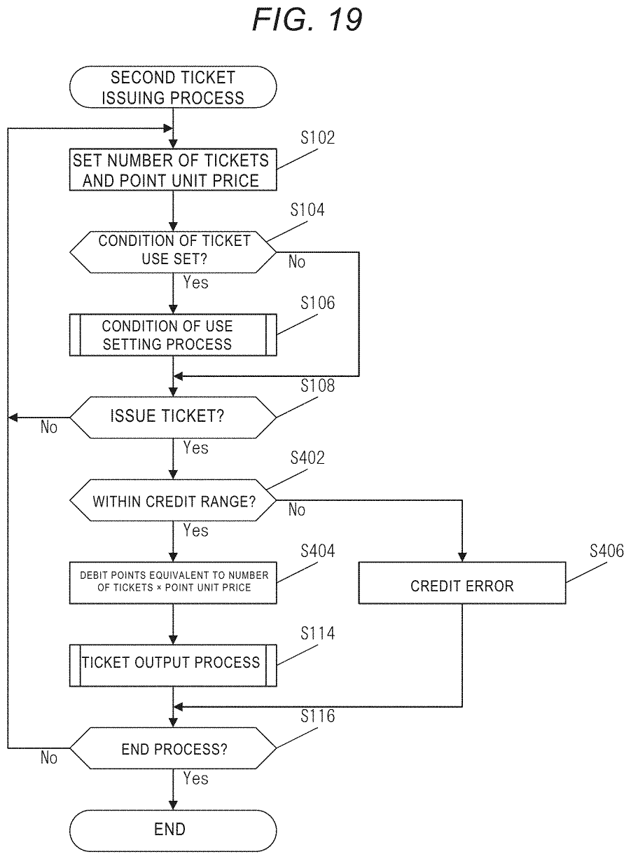

FIG. 19 is a drawing that replaces the ticket issuing process of FIG. 10 of the first embodiment. In FIG. 19, the same reference signs are allotted to processes the same as in FIG. 10.

FIG. 19 shows that when an instruction to execute a ticket issuing process is given in step S108, the control unit 100 determines whether or not a total number of points of tickets to be issued is within a credit range (step S402).

Herein, a credit range oi points for which a ticket can be issued is set in advance for a user. The credit range may be set by a service provider that manages the points, or may be set by a financial institution. Also, a manager may set a credit range with respect to each user. A set credit range may be stored by the point management server 20, or may be stored by the ticket management server 10. Also, a server that manages credit information may be provided separately.

When the total number of tickets to be issued is within the credit range, debit points equivalent to the number of tickets multiplied by the point unit price are generated (step S402: Yes, proceed to step S404). Meanwhile, when the credit range is exceeded, a credit error occurs, and the control unit 100 does not issue a ticket (step S402: No, proceed to step S406).

It is sufficient that the debit points are stored by any server or device. For example, the debit points may be stored by the ticket management server 10, or may be stored by the point management server 20. Further, an offsetting of the debit points is executed at a predetermined timing.

For example, the debit points may be offset by points in a wallet (a user wallet or a ticket wallet) of a user corresponding to the debit points in each predetermined period (for example, the end of a month). Also, debit points may be offset by wallet points at a stage at which the expiry date of an issued ticket is reached.

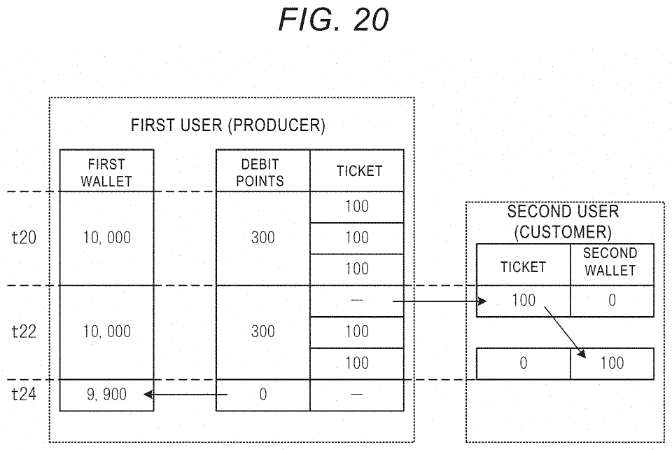

FIG. 20 is a drawing wherein an increase and decrease of points in the embodiment is shown chronologically and schematically. Firstly, at t20, a first user issues three tickets to which “100” points are allotted. At this time, the number of debit points becomes “300”, but the balance in the user wallet remains at “10,000” points.

Continuing, a second user uses a ticket. Because of this, a second wallet (user wallet) of the second user increases by “100” points. Together with this, the relevant ticket is deleted (t22).

Further, a process of offsetting the debit points is executed lastly. In this case, although the number of debit points had been “300”, there are two unused tickets, worth “200” points. Consequently, “100” points have been used, because of which the points in the first wallet decrease by “100”, becoming “9,900”(t24).

In this way, according to the embodiment, a ticket can be issued by utilizing debit points, even when there is not a sufficient advance balance in a wallet of the point management server 20. Also, only a number of tickets actually used is paid for.

### 3. Third Embodiment

A third embodiment will be described. In the third embodiment, a description will be given of an embodiment in a case wherein points are not deducted from a wallet of an issuer when a ticket is issued, but debit points are not utilized either. In the embodiment, only differences from the first embodiment and the second embodiment will be described, and a description of common portions will be omitted due to being the same as in the first embodiment and the second embodiment.

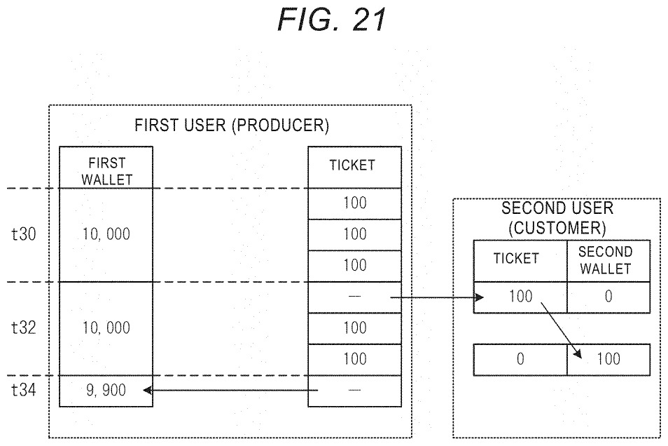

FIG. 21 is a drawing wherein an increase and decrease of points in the embodiment is illustrated chronologically and schematically. Firstly, at t30, a first user issues three tickets to which “100” points are allotted. At this time, tickets to the value of “300” points are issued, but the balance in the user wallet remains at “10,000” points.

The issued points of the tickets are preferably issued within the credit range of the user. Also, the ticket points are managed instead of the debit points of the second embodiment.

Continuing, a second user uses a ticket. Because of this, a second wallet of the second user increases by “100” points. Together with this, the relevant ticket is deleted (t32).

Further, a process of offsetting the points of a used ticket is executed lastly. In this case, although the number of points of the three issued tickets had been “300”, there are two unused tickets, worth “200” points. Consequently, “100” points have been used, because of which the balance in the first wallet decreases by “100”, becoming “9,900” (t34).

In this way, according to the embodiment, a transfer of points can be carried out simply by managing a used ticket, without utilizing debit points.

A process of offsetting ticket points may be executed as needed. For example, the balance in the first wallet may be reduced by “100” points at t32 when one ticket is used.

In this case too, timings of a ticket being issued and points being used (when payment is made) can be separated.

### 4. Fourth Embodiment

A fourth embodiment will be described. In the heretofore described embodiments, a transfer of points managed by the point management server 20 has been described. In the fourth embodiment, a description will be given of an embodiment in a case wherein points are a virtual currency. In the embodiment, only differences from the first embodiment will be described, and a description of common portions will be omitted due to being the same as in the first embodiment.

In the description of the overall configuration of FIG. 2, the first embodiment is such that the point management server 20 is connected, and points are managed as an overall system. In the embodiment, a description will be given assuming that a virtual currency management system that manages a virtual currency is connected instead of the point management server 20. The virtual currency management system is realized using a blockchain, or distributed ledger technology (DLT) similar to a blockchain.

Further, the embodiment can be realized by utilizing a virtual currency instead of the points of the heretofore described embodiments.

For example, when describing with reference to FIG. 9(a), a virtual currency is managed by the first wallet of the first user. Further, the first user utilizes the virtual currency of the first wallet when issuing a ticket. Also, by the second user using a received ticket, a balance of a virtual currency in the second wallet increases.

Also, in the case of the second embodiment, a payment of debit points is carried out with a virtual currency of the first user. In this way, a person skilled in the art can easily apply each of the heretofore described embodiments to a system that utilizes a virtual currency.

In the heretofore described embodiment, a system that utilizes a virtual currency has been described, but a system that utilizes electronic money or a banking system (Internet banking) is also applicable.

In this case, an electronic money balance or a bank account balance of a utilizer and a ticket balance are correlated instead of a virtual currency balance.

### 5. Fifth Embodiment

5. 1 Overall System

A fifth embodiment will be described. The embodiment is an embodiment wherein the heretofore described point system is utilized, but is an embodiment wherein movement of a point balance is clearly described. In the embodiment, only differences from the first embodiment will be described, and a description of common portions will be omitted as necessary due to being the same as in tie first embodiment.

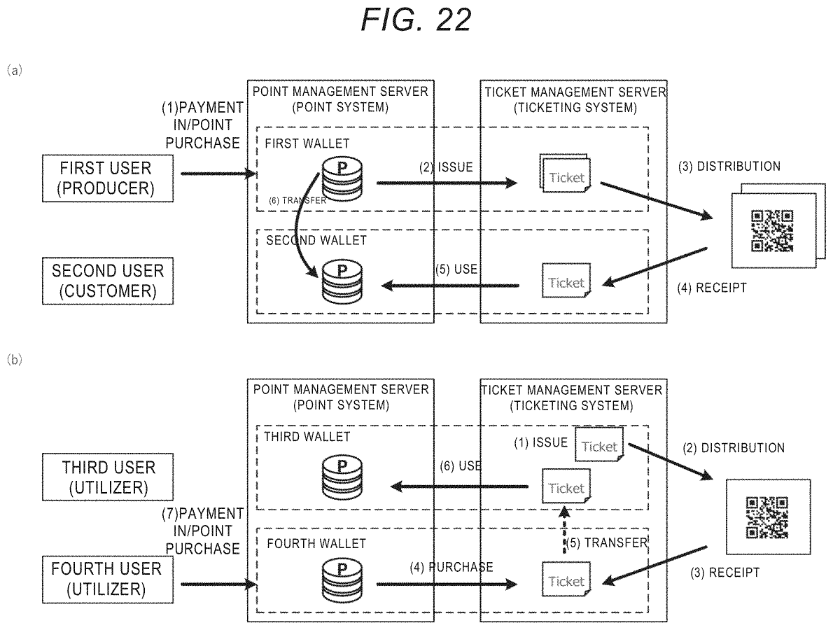

An overall flow of the embodiment will be described, with reference to FIG. 22. FIG. 22(a) is a working example illustrating a transfer of points from a wallet of a first user (for example, a producer), who is a ticket issuer/sender, to a wallet of a second user (for example, a customer or a consumer), who is a recipient.

Firstly, the first user purchases (charges) points for a first wallet ((1) in FIG. 22(a)). By so doing, the number of points (point balance) in the user wallet of the first user increases. When debit points (a negative point balance) are permitted in the first wallet, as in a heretofore described embodiment, there is no need to purchase points. In this case, a point management server (point system) may manage the balance in the first wallet in advance as negative points within a credit range.

Continuing, the first user issues a ticket by utilizing ((2) in FIG. 22(a)). At this time, the balance in a ticket wallet increases by an amount equivalent to the issued ticket. Also, the balance in the user wallet has not changed at this point.

The first user generates an identification code based on the issued ticket, and outputs the identification code ((3) of FIG. 22(a)). By so doing, the first user can distribute the ticket. Ticket distribution is carried out by, for example, printing a two-dimensional code in such a way that the two-dimensional code can be recognized by a terminal device of the second user. The printed two-dimensional code may be attached to a product, or may be distributed as a printed ticket. Also, the two-dimensional code may be displayed on a display or the like of each device.

The second user, for example, films the identification code (two-dimensional code) using the camera unit 430 of the terminal device 40. That is, the second user receives the distributed ticket by acquiring the identification code ((4) in FIG. 22(a)). Specifically, the terminal device 40 recognizes a token from the filmed identification code. Because of this, the ticket is identified from the recognized token. That is, the second user can receive the ticket corresponding to the recognized token from the ticket management server 10 (the ticketing system).

By the second user using the received ticket, the balance in a user wallet of the second user increases ((5) in FIG. 22(a)). At this time, the balance in the user wallet of the first user decreases. Also, the ticket used by the second user is deleted from the ticket wallet of the first user.

Herein, a timing of the ticket used by the second user being deleted may be the timing of the second user receiving the ticket ((4) in FIG. 22(a)), or may be the timing of the ticket being used ((5) in FIG. 22(a)).

Also, in FIG. 22, the ticket is used after the ticket is received, but this series of events may be executed collectively. That is, the ticket may be used, and the balance in the user wallet of the second user increase, at the timing of the second user receiving the ticket. Together with this, the balance in the user wallet of the first user may decrease, the balance in the ticket wallet of the first user may decrease, or the ticket of the first user may be deleted, at the same time. Timings of these balances increasing or decreasing can be changed as appropriate in accordance with the process.

Also, the system can also be utilized when paying and for a simple point transfer. FIG. 22(b) is a drawing illustrating a working example wherein points are transferred to a user wallet of a third user (a third wallet) from a user wallet of a fourth user (a fourth wallet).

Firstly, the third user issues a ticket indicating the number of points the third user wishes to receive in the ticket management server 10 ((1) in FIG. 22(b)). Also, the third user outputs an identification code (two-dimensional code) including a token that identifies the issued ticket, and distributes the ticket ((2) i.i FIG. 22(b)).

The fourth user, for example, reads and films the output two-dimensional code using the camera unit 430 of the terminal device 40, thereby recognizing the token included in the two-dimensional code. That is, the fourth user receives the ticket distributed by the third user ((3) in FIG. 22(b)).

Herein, when the fourth user uses the ticket, the number of points indicated by the ticket is subtracted from the points in the user wallet of the fourth user. Various methods are conceivable as an arrangement for carrying out the point subtraction, but as an example, the fourth user purchases (charges) points for the user wallet of the fourth user ((7) in FIG. 22(b)). Further, by the fourth user using the ticket, points are transferred from the user wallet of the fourth user to a ticket wallet equivalent to the ticket, and the balance in the ticket wallet decreases ((6) in FIG. 22(b)).

Further, the ticket of the fourth user is transferred to the third user ((5) in FIG. 22(b)). Specifically, the points in the ticket wallet of the third user increase by a number of points equivalent to the points subtracted from the ticket wallet of the fourth user. Further, by the third user using the ticket, the point balance in the user wallet of the third user increases ((6) in FIG. 22(b)). In this way, the wallet balance of the third user increases by a number of points equivalent to the number subtracted from the wallet of the fourth user. As the third user can confirm that a payment has been carried out using ticket information, the timing of points being received in the wallet of the third user need not be synchronized with an individual payment.

By a ticket of the system being utilized in this way, a transfer of points between wallets can be carried out without being synchronized with a payment.

Although a transfer of points is carried out via ticket wallets, points may be transferred directly between user wallets. That is, when a ticket is used, the balance of points in the user wallet of the fourth user decreases by an amount equivalent to the points allotted to the ticket. Together with this, the balance of points in the user wallet of the third user increases. In this way, the balance in a user wallet may be caused to increase or decrease.

5.2 Process Flow

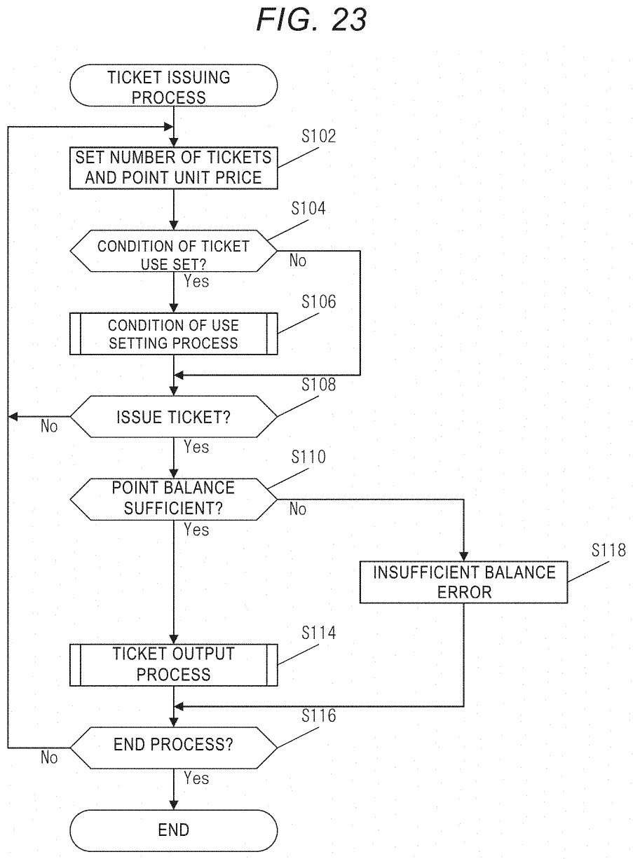

A process flow of the embodiment will be described, with reference to FIG. 23 and FIG. 24. FIG. 23 is a drawing that replaces the ticket issuing process (FIG. 10) of the first embodiment, and FIG. 24 is a drawing that replaces the payment process (FIG. 12) of the first embodiment. The same reference signs are allotted to identical processes, and the description will be given centered on differing points.

FIG. 23 is a ticket issuing process executed by the control unit 100. Unlike in FIG. 10, the point balance in a user wallet is not caused to change when a ticket is issued (step S108: Yes, proceed to step S110, and proceed to step S114).

The control unit 100 confirms in step S110 whether there is a point balance such that a ticket can be issued in a user wallet. This process may confirm the balance in the user wallet of a current issuer, or may confirm a credit range of the issuer. The balance need not be confirmed at this time.

FIG. 24 is a payment process executed by the control unit 100. Unlike in FIG. 12, points of an issuer are subtracted when a used ticket is deleted (step S320). That is, when a ticket is used by a recipient, the used ticket is deleted (step S314). At this time, the points allotted to the used ticket are subtracted from the balance in the user wallet of the issuer Further, an equivalent number o: points are added to the balance of points managed by the ticket wallet of the recipient or points managed by the user wallet of the recipient. Because of this, the point balance of the recipient increases.

In the same way as in the first embodiment, a signal is received from the terminal device 40 before step S314, and a ticket deletion and a point addition or subtraction may be carried out after the signal.

In this way, according to the embodiment, a timing of a point balance managed by a wallet (a user wallet or a ticket wallet) of an issuer decreasing can be a timing of a recipient acquiring or using a ticket. That is, a timing of a point movement can be adjusted to a timing of an issuer issuing a ticket or a timing of a recipient using a ticket.

### 6. Sixth Embodiment

Continuing, a sixth embodiment will be described. The sixth embodiment is an embodiment for describing that fourth ticket data can be used as ticket data. In the embodiment, only differences from the first embodiment will be described, and a description of common portions will be omitted as necessary due to being the sane as in the first embodiment.

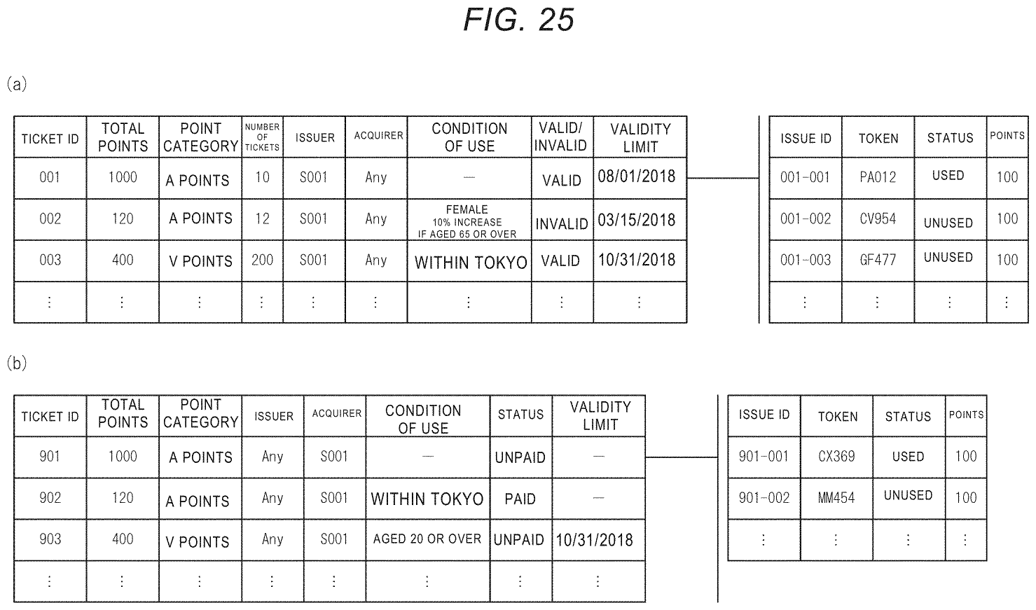

Fourth ticket data are written based on the ticket data of the first embodiment. As shown in FIG. 25(a), ticket ID and a total number of points are stored as ticket data. In addition to this, a point category, a number of tickets, an issuer, an acquirer, a condition of use, a valid/invalid category, and an expiry date are stored as appropriate as needed Also, each ticket is stored correlated to an item of ticket ID.

For example, a table on the left side of FIG. 25(a) shows data relating to a whole of a ticket. Also, a table on the right side of FIG. 25(a) shows data relating to each ticket. When comparing with the ticket data illustrated in FIG. 4 and FIG. 5, points (a unit price) are allotted to each ticket in the data relating to each ticket. Because of this, a person using a ticket can receive the points allotted to the ticket.

Ticket data of FIG. 25(b) are based on the ticket data of FIG. 5(b). That is, points are stored for each ticket.

By points being stored directly for each ticket in this way, points can managed for each ticket in the system. Also, it is sufficient that a total number of points, a number of tickets, and a unit price of each point are stored as necessary in the ticket data of the embodiment. Also, the number of points of issued tickets may be stored as the total number of points, or the total number of points may be the total number of points allotted to valid tickets.

### 7. Application Example

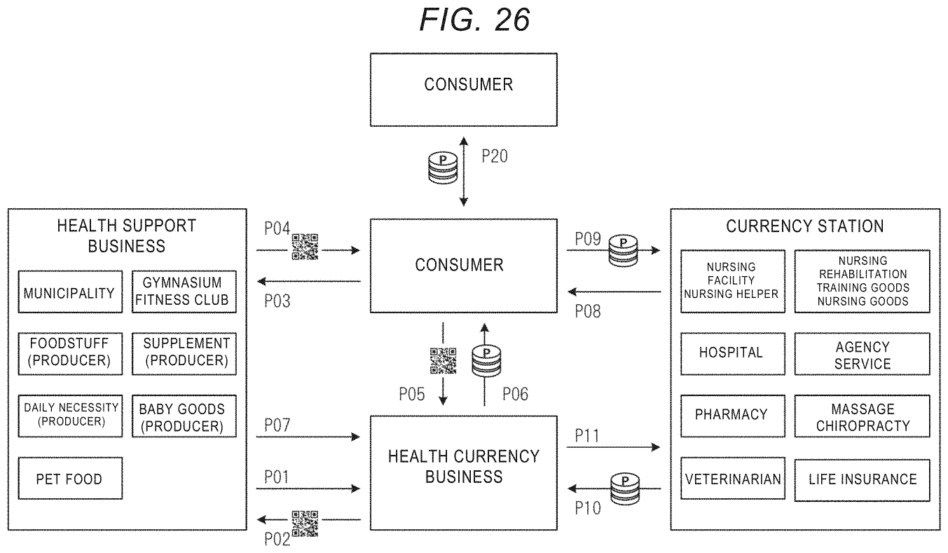

An application example of the system will be described, with reference to FIG. 26. For example, a business that provides a product or a service issues the heretofore described points with respect to a consumption of tangible or intangible goods the business wishes to promote to a consumer for the sake of health. The consumer actively consumes tangible or intangible goods with which points accumulate. Because of this, in addition to leading to an elimination of concern regarding the future, the consumer can resultantly lead a healthy life. Also, by paying medical fees or welfare fees with points, the consumer can utilize a hospital or an institution without concern, even when an individual charge increases.

For example, with reference to FIG. 26, a description will be given with points as a virtual currency, called a “health currency”, a service provider that issues the health currency as a health currency business, a place that gives the health currency to a consumer as a health support business, and a place where the consumer utilizes the health currency as a currency station.

Firstly, the health support business pays a commission for issuing the health currency from the health currency business (P01). Herein, the health currency business issues data (for example, a ticket token) with which a ticket (two-dimensional code) can be issued (P02).

The consumer purchases, for example, a product or a service from the health support business (P03). The health support business allots a ticket (two-dimensional code) to, for example, the product, or gives a ticket (two-dimensional code) to the consumer who receives the service (P04).

The consumer reads the two-dimensional code, and transmits the token recognized from the two-dimensional code to the health currency business (P05). The health currency business can identify a ticket from the token, and issues the health currency, which is the points allotted to the ticket, to the consumer (P06). Also, the health support business pays cash corresponding to the amount of health currency issued to the health currency business (P07).

The consumer purchases a product or receives a provision of a service at the currency station (P08). At this time, unlike at the health support business, payment to a business or an institution that is the currency station is carried out using the health currency (P09).

The health currency business buys the health currency from the business or the institution that is the currency station (P10), and pays cash (P11). Also, points can also be exchanged between consumers (P20).

By the point system described in the heretofore described embodiments being utilized in this way, a flexible arrangement utilizing points can be provided.

8. Modifications

Heretofore, embodiments of the invention have been described in detail, with reference to the drawings, but a specific configuration is not limited to the embodiments, and design and the like that does not depart from the scope of the invention is also included within the scope of the claims.

Also, the invention has been described based on the drawings and working examples In the heretofore described embodiments, but those skilled in the art will easily be able to carry out various modifications or amendments based on the specification and the drawings. Consequently, these modifications and amendments are included in the scope of the invention. For example, functions and the like included in each configuration, each means, and each step can be redisposed in such a way that there is no logical inconsistency, and multiple means, steps, or the like can be combined into one, or divided.

Also, although a system in which a server device is utilized has been described in the heretofore described embodiments, it is sufficient that a system can realize equivalent functions. For example, a case wherein a blockchain system is utilized instead of each server device has been described, but implementation can also be carried out by, for example, using a smart contract of a blockchain system instead of the ticket management server 10. In this case, the details of the heretofore described embodiments can be realized by one or both of a point managing function and a ticket managing function being implemented using a blockchain (distributed ledger) and a smart contract (a program operated in a blockchain). For example, the storage unit 110 of the heretofore described embodiments may be caused to correspond to a distributed ledger (blockchain), and the control unit 100 may be caused to correspond to a smart contract.

Also, a program operating in each device in the embodiments is a program that controls a computing device such as a CPU (a program that causes a computer to function) in such a way as to realize the functions of the heretofore described embodiments. Further, information handled by these devices is temporarily accumulated in a temporary storage device (for example, a RAM) when being processed, and subsequently stored in various kinds of ROM, HDD, or SSD storage device, and a reading, an amendment, or a writing is carried out as necessary by a CPU.

Also, when distributing on a market, the program can be distributed stored on a portable recording medium, or transmitted to a server computer connected via a network such as the Internet. In this case, a server computer storage device is, of course, also included in the invention.

### REFERENCE SIGNS LIST

1 System
   10 Ticket management server
      100: control unit 110: storage unit 120: communication unit 130: input/output unit
   20 Point management server
      200: control unit 210: storage unit 220: communication unit 230: input/output unit
      30 Management device
         300: control unit 310: storage unit 320: communication unit 330: display unit 340: printing control unit
            32 Display device
            34 Printing device
      40 Terminal device
         400: control unit 410: storage unit 420: communication unit 430: camera unit 440: display unit 450: operation unit

1. A ticketing system, comprising:
a terminal device;
a point management device that manages user points; and
a ticket management device, wherein
the ticket management device includes:
an issuing unit that issues tickets to which a number of points associated to points of a first user are allotted;
an output unit that outputs identification information based on the tickets;
a receiving unit that receives user information and the identification information from the terminal device;
an identification unit that identifies a ticket corresponding to the identification information; and
a ticket processing unit that adds the number of points allotted to the identified ticket to points of a second user identified from the user information, and deletes the ticket for which the points have been added from the issued tickets.

2. The ticketing system according to claim 1, wherein the output unit outputs a two-dimensional code including the identification information, and
the terminal device includes
a user information storage unit in which user information is stored,
an acquisition unit that acquires identification information from the two-dimensional code, and
a transmitting unit that transmits the identification information and the user information to the ticket management device.

3. The ticketing system according to claim 1, wherein the output unit outputs identification information including a token for identifying the ticket, and
the identification unit extracts the token from the identification information, and identifies the ticket corresponding to the token.

4. The ticketing system according to claim 1, wherein the ticket management device further includes a condition of use storage unit in which a condition of ticket use is stored, and
the ticket processing unit adds the number of points to the points of the second user when the second user meets the condition of ticket use according to the user information, and deletes the ticket for which the points have been added from the issued tickets.

5. The ticketing system according to claim 1, wherein the issuing unit subtracts the number of points from the points of the first user when the ticket is deleted.

6. The ticketing system according to claim 1, wherein the issuing unit subtracts the number of points from the points of the first user when the ticket is issued.

7. The ticketing system according to claim 1, wherein the ticket management device manages the number of points as a debt of the first user when the issuing unit issues the ticket, and
further includes a subtraction unit that subtracts the debt of the first user from the points of the first user at a predetermined timing.

8. The ticketing system according to claim 1, further including a change unit that changes the number of points allotted to the issued ticket.

9. A ticketing system that is a payment system comprising:
a terminal device;
a point management system that manages user points; and
a ticket management device, wherein
the ticket management device generates a token including information relating to a number of points associated to points of a first user and a condition of use, and issues a ticket on which identification information in which the token is included is described,
the terminal device acquires the token from the identification information of the ticket, and transmits the token and information relating to a second user corresponding to the terminal device to the ticket management device, and
the ticket management device
identifies a ticket from the received token,
subtracts the number of points allotted to the identified ticket from the points of the first user,
adds the number of points allotted to the identified ticket to points of the second user,
and deletes the identified ticket from issued tickets.

10. A ticket management device, comprising:
a control unit; and
a communication unit that carries out communication with a point management device that manages a terminal device and user points, wherein
the control unit
issues tickets to which a number of points associated to points of a first user are allotted,
outputs identification information based on the tickets,
receives user information and the identification information via the communication unit from the terminal device,
identifies a ticket corresponding to the identification information,
adds the number of points allotted to the identified ticket to points of a second user identified from the user information, and
deletes the ticket for which the points have been added from the issued tickets.

11. A payment method in a ticketing system including a point management device that manages user points and a ticket management device, wherein
the ticket management device includes:
a step of issuing tickets to which a number of points associated to points of a first user are allotted;
a step of outputting identification information based on the tickets;
a step of receiving user information and the identification information;
a step of identifying a ticket corresponding to the received identification information; and
a step of adding the number of points allotted to the identified ticket to points of a second user identified from the user information, and deleting the ticket for which the points have been added from the issued tickets.
